(19) United States
(12) Patent Application Publication
(10) Pub. No.: US 2025/0111785 A1
(43) Pub. Date: Apr. 3, 2025

(54) MARINE SURFACE VESSEL TRAJECTORY TRACKING CONTROL

(71) Applicant: Ohio University, Athens, OH (US)

(72) Inventors: Jianchao Zhu, Athens, OH (US); Miguel Sempertegui Sosa, Athens, OH (US)

(21) Appl. No.: 18/902,224

(22) Filed: Sep. 30, 2024

Related U.S. Application Data
(60) Provisional application No. 63/586,469, filed on Sep. 29, 2023.

(51) Int. Cl. G08G 3/00; B63B 79/10; B63B 79/30; B63B 79/40

(52) U.S. Cl. CPC G08G 3/00; B63B 79/10; B63B 79/30; B63B 79/40; B63B 2213/00

(57) ABSTRACT

Systems, methods, and computer program products for controlling a marine surface vessel. Nominal position and nominal heading signals are received from a trajectory planner, and nominal force and nominal moment signals generated based thereon. A velocity tracking error signal is generated based on the sensed velocity signal, and a yaw rate tracking error signal is generated based on the sensed yaw rate signal. A force tracking error control signal is generated based on the velocity tracking error signal, and a moment tracking error control signal is generated based on the yaw rate tracking error signal. A force command signal is generated by summing the nominal force and force tracking error control signals, and a moment command signal is generated by summing the nominal moment and moment tracking error control signals. The force and moment command signals are used to control one or more actuators of the marine surface vessel.

### CROSS-REFERENCE TO RELATED APPLICATIONS

The present application claims the filing benefit of co-pending U.S. Provisional Application Ser. No. 63/586,469, filed Sep. 29, 2023, the disclosure of which is incorporated by reference in its entirety.

### FIELD OF THE INVENTION

The present invention relates generally to trajectory tracking control, and specifically to the automatic control of marine surface vessels using trajectory tracking control.

### BACKGROUND

Existing automatic marine surface vessels are typically designed using independent longitudinal motion control (i.e., surge or cruise control) and lateral-directional control (i.e., sway-yaw or steering control). Typical marine surface vessels are underactuated with two degrees of freedom actuators (i.e. throttle and steering) for three degrees of freedom motions. To date, this remains a challenge for marine surface vessel motion controllers to overcome. There have been some new developments for marine surface vessel motion control, but these control techniques tend to be overly complicated and have limited effectiveness.

The development of autonomous marine surface vessels has been a subject of interest and active research for the past two decades, with important roles in applications such as environmental monitoring and search and rescue applications. There have also been developments toward the construction of large-scale autonomous marine surface vessels for the transportation of goods. Effective motion control is a key aspect to successfully achieve these applications, and a topic of great interest and research in the field of autonomous marine surface vessels.

Motion control has been tackled with different control objectives, such as station keeping, path following, and trajectory tracking. It has also been approached from a number of control techniques. These control techniques generally fall into one of two main categories, namely a model-based approach and a data-driven based approach. Several approaches to the motion control problem for marine surface vessels falling into one of these two categories have been proposed.

Data-driven techniques include the development of motion control algorithms, and the use of backstepping to derive a neural network adaptive control for a fully actuated vessel to accomplish tracking of a time parameterized path. Other proposed approaches have used full state feedback with a state observer to implement output trajectory tracking controllers and output state controllers designed while applying an adaptive neural network to approximate unknown parameters of the marine surface vessel in order to achieve trajectory tracking along a desired path. Still others have used a robust neural controller design to solve the path following problem only, and solving the trajectory tracking problem using neural network approximators to estimate uncertain dynamics and disturbances. Still others have used an asymptotic trajectory tracking strategy based on adaptive neural network control for a fully actuated marine surface vessel, which includes an actuator in the sway direction, thus, solving the lateral error problem. Lastly, a local control network has been used to generate a number of controllers, each working in a particular region of operation of the vessel while estimating its response.

Model-based approaches to the problem of trajectory tracking may separate the problem into a kinematic problem and a dynamic problem. A sliding mode controller has been tested in order to achieve station keeping of an autonomous marine surface vessel. While the task was achieved, additional considerations were necessary to mitigate the chattering effect, which is common in sliding mode controllers. The problem of trajectory tracking of marine surface vessels has also been approached as a maneuvering problem. In this approach, the problem was formulated as a path following control subtask and a trajectory tracking control subtask. Path following requires the vessel to traverse a desired path constrained by its kinematics with no consideration of vessel acceleration and dynamic constraints. In contrast, trajectory tracking control deals with variable velocity along a desired path, force and moment generation, and tracking error regulation and stabilization, which is a much more challenging control problem. Separating the kinematic and dynamic tasks is an approach that has given rise to a variety of solutions to the geometric control objective. For example, one solution to the path following task has proposed using a nonlinear controller that guaranties asymptotic stability for an underactuated vessel. However, this approach is only designed to work for a time-invariant steering problem.

A trajectory linearization control architecture has also been applied to marine vessels in various approaches. One approach applied trajectory linearization control to a one degree of freedom Norrbin steering model and a steering dynamics model. The trajectory linearization control approach has also been applied to a three degrees of freedom model. However, this controller design did not include allocation of the control signals to actuators and disregarded the presence of lateral forces in the motion of the vessel. The nominal controller tuning was not described, and its effect on vessel performance was not explicitly discussed.

Thus, there is a need for improved systems, methods, and computer program products for controlling marine surface vessels.

### SUMMARY

The disclosed multi-nested loop trajectory linearization guidance control system includes two sub-controllers, namely a nominal controller and a tracking error controller. The nominal controller is an open-loop controller that takes the desired nominal trajectory as input to computes nominal control signals. The nominal control signals track the desired trajectory without the need for sensing the motion variables or designing complex nonlinear feedback control that may cause instability. The tracking error controller is a closed-loop feedback controller that takes the sensed tracking error to produce a corrective control along the desired trajectory. Because the open-loop controller has achieved approximate tracking with sufficient accuracy such that the tracking errors are small, the tracking errors can be effectively eliminated with exponential stability using a linear controller.

The nominal controller includes a translational kinematics module that generates a nominal velocity signal V^{nom}, a translational dynamics module that generates a nominal force signal F^{nom} and nominal yaw angle signal ψ^{nom}, a nominal force allocation module that nominal moment signal N^{m,nom}. The tracking error controller receives each of the nominal signals *ₙₒₘ and generates a corresponding system stabilizing closed-loop tracking error control signal *_{ctrl}. In this context, the desired position and course angle signals of the vessel relative to the navigation frame (n-frame) as generated by a trajectory designer may be referred to as the nominal trajectory x_{ref}, y_{ref}, χ_{ref}. As the overall system is partitioned into four nested trajectory linearization controllers, the reference trajectories for each sub-controller are called a nominal trajectory *ₙₒₘ which is an approximated version of the exact/ideal reference trajectories. The output of the open-loop control controllers are called nominal control *ₙₒₘ, and the output of the closed-loop feedback controllers are denoted *_{ctrl}. The sum of these two signals *_{com}=*ₙₒₘ+*_{ctrl} is the commanded trajectory for the next inner-loop subsystem to track.

In an aspect of the disclosure, a method of controlling a marine surface vessel is disclosed. The method includes receiving a nominal position signal and a nominal heading signal each corresponding to a planned trajectory of the marine surface vessel in a navigation frame, generating a plurality of nominal control signals based on one or more of the nominal position signal and the nominal heading signal, the nominal control signals including a nominal force signal and a nominal moment signal, receiving a plurality of sensed value signals including a sensed position signal, a sensed velocity signal, a sensed yaw angle signal, and a sensed yaw rate signal, generating a plurality of tracking error signals including a position tracking error signal generated based on the sensed position signal, a velocity tracking error signal generated based on the sensed velocity signal, a yaw angle tracking error signal generated based on the sensed yaw angle signal, and a yaw rate tracking error signal generated based on the sensed yaw rate signal, generating a plurality of tracking error control signals including a velocity tracking error control signal generated based on the position tracking error signal, a force tracking error control signal generated based on the velocity tracking error signal, a yaw tracking error control signal generated based on a sway component of the velocity tracking error signal, and a moment tracking error control signal generated based on the yaw rate tracking error signal, generating a plurality of command signals including a force command signal generated by summing the nominal force signal and the force tracking error control signal and a moment command signal generated by summing the nominal moment signal and the moment tracking error control signal, and controlling the one or more actuators of the marine surface vessel based on the force command signal and the moment command signal.

In an embodiment of the disclosed method, generating the nominal force signal may include pseudo-differentiating the nominal position signal to generate an n-frame nominal velocity signal, applying a first inverse translational kinematics function including a nominal yaw angle signal as a coefficient of rotation to the n-frame nominal velocity signal to generate a b-frame nominal velocity signal, pseudo-differentiating the nominal b-frame velocity signal to generate a b-frame nominal acceleration signal, and applying an inverse translational dynamics function including the nominal yaw rate signal, the b-frame nominal velocity signal, the b-frame nominal acceleration signal, and a mass of the marine surface vessel to generate the b-frame nominal force signal.

In another embodiment of the disclosed method, generating the force tracking error control signal may include subtracting a sensed position signal from the nominal position signal to generate an n-frame position tracking error signal, applying the inverse translational kinematics function including the nominal yaw angle signal as the coefficient of rotation to the position tracking error signal to generate a b-frame down-range error vector signal, applying a first proportional-integral control law to the b-frame down-range error vector signal to generate a velocity tracking error control signal, summing the nominal velocity signal and the velocity tracking error control signal to generate a velocity command signal, subtracting the sensed velocity signal from the velocity command signal to generate the velocity tracking error signal, and applying a second proportional-integral control law to the velocity tracking error signal to generate the force tracking error control signal.

In another embodiment of the disclosed method, generating the force command signal may include summing the nominal force signal and the force tracking error control signal.

In another embodiment of the disclosed method, generating the moment tracking error control signal may include generating a yaw angle command signal based on the force command signal, subtracting a sensed yaw angle signal from the yaw angle command signal to generate a yaw angle tracking error signal, applying a third proportional-integral control law to the yaw angle tracking error signal to generate a yaw rate tracking error control signal, summing the yaw rate tracking error control signal and the nominal yaw rate signal to generate a yaw rate command signal, subtracting the sensed yaw rate signal from the yaw rate command signal to generate the yaw rate tracking error signal, and applying a fourth proportional-integral control law to the yaw rate tracking error signal to generate the moment tracking error control signal.

In another embodiment of the disclosed method, generating the moment command signal may include summing the nominal moment signal and the moment tracking error control signal.

In another embodiment of the disclosed method, generating the nominal moment signal may include using the nominal lateral force signal to compute a nominal sideslip angle signal based on the vessel's inverse force model, subtracting the nominal sideslip angle signal from the nominal heading angle signal and lowpass filtering the difference to generate a nominal yaw angle signal, pseudo-differentiating the nominal yaw angle signal to generate a nominal yaw rate signal, pseudo-differentiating the nominal yaw rate signal to generate a nominal yaw acceleration signal, and multiplying the nominal yaw acceleration signal by a rotational inertia of the marine surface vessel to generate the nominal moment signal.

In another embodiment of the disclosed method, determining the nominal yaw angle signal may include generating a nominal velocity signal based on the nominal position signal, generating a nominal yaw rate signal based on the nominal heading signal, generating a nominal force signal including a nominal surge component and a nominal sway component based on the nominal yaw rate signal and the nominal velocity signal, determining a required sway velocity to overcome the lateral drift based on the sway component of the nominal force signal and the vessel's force model parameters, generating a nominal sideslip signal based on a ratio of the required sway velocity to the surge component of the nominal velocity, and subtracting the nominal sideslip signal from the nominal heading signal to generate the nominal yaw angle signal.

In another embodiment of the disclosed method, generating the nominal velocity signal may include applying a second inverse translational kinematics function including the nominal heading signal as the coefficient of rotation to the pseudo-differentiated n-frame nominal position signal to generate the nominal b-frame velocity signal.

In another embodiment of the disclosed method, generating the nominal yaw rate signal may include pseudo-differentiating the nominal heading signal to generate the nominal yaw rate signal.

In another embodiment of the disclosed method, the marine surface vessel has a mass, and generating the nominal force signal may include pseudo-differentiating the nominal velocity signal to generate a nominal acceleration signal, applying a second inverse translational dynamics function including the nominal yaw rate signal as the coefficient of rotation to the nominal velocity signal to generate a result, subtracting the result from the nominal acceleration signal to generate a difference, and multiplying the difference by the mass of the marine surface vessel to generate the nominal force signal.

In another aspect of the disclosure, a system for controlling a marine surface vessel is disclosed. The system includes one or more processors and a memory including program code. When executed by the one or more processors, the program code causes the system to receive a nominal position signal and a nominal heading signal each corresponding to a planned trajectory of the marine surface vessel in a navigation frame, generate a plurality of nominal control signals based on one or more of the nominal position signal and the nominal heading signal, the nominal control signals including a nominal force signal and a nominal moment signal, receive a plurality of sensed value signals including a sensed position signal, a sensed velocity signal, a sensed yaw angle signal, and a sensed yaw rate signal, generate a plurality of tracking error signals including a position tracking error signal generated based on the sensed position signal, a velocity tracking error signal generated based on the sensed velocity signal, a yaw angle tracking error signal generated based on the sensed yaw angle signal, and a yaw rate tracking error signal generated based on the sensed yaw rate signal, generate a plurality of tracking error control signals including a velocity tracking error control signal generated based on the position tracking error signal, a force tracking error control signal generated based on the velocity tracking error signal, a yaw tracking error control signal generated based on a sway component of the velocity tracking error signal, and a moment tracking error control signal generated based on the yaw rate tracking error signal, generate a plurality of command signals including a force command signal generated by summing the nominal force signal and the force tracking error control signal and a moment command signal generated by summing the nominal moment signal and the moment tracking error control signal, and control the one or more actuators of the marine surface vessel based on the force command signal and the moment command signal.

In an embodiment of the disclosed system, the program code may cause the system to generate the nominal force signal by pseudo-differentiating the nominal position signal to generate an n-frame nominal velocity signal, applying a first inverse translational kinematics function including a nominal yaw angle signal as a coefficient of rotation to the n-frame nominal velocity signal to generate a b-frame nominal velocity signal, pseudo-differentiating the nominal b-frame velocity signal to generate a b-frame nominal acceleration signal, and applying an inverse translational dynamics function including the nominal yaw rate signal, the b-frame nominal velocity signal, the b-frame nominal acceleration signal, and a mass of the marine surface vessel to generate the b-frame nominal force signal.

In another embodiment of the disclosed system, the program code may cause the system to generate the force tracking error control signal by subtracting a sensed position signal from the nominal position signal to generate an n frame position tracking error signal, applying the inverse translational kinematics function including the nominal yaw angle signal as the coefficient of rotation to the position tracking error signal to generate a b frame down-range error vector signal, applying a first proportional-integral control law to the b-frame down-range error vector signal to generate a velocity tracking error control signal, summing the nominal velocity signal and the velocity tracking error control signal to generate a velocity command signal, subtracting the sensed velocity signal from the velocity command signal to generate the velocity tracking error signal, and applying a second proportional-integral control law to the velocity tracking error signal to generate the force tracking error control signal.

In another embodiment of the disclosed system, the program code may cause the system to generate the force command signal by summing the nominal force signal and the force tracking error control signal.

In another embodiment of the disclosed system, the program code may cause the system to may cause the system to generate the moment tracking error control signal by generating a yaw angle command signal based on the force command signal, subtracting a sensed yaw angle signal from the yaw angle command signal to generate a yaw angle tracking error signal, applying a third proportional-integral control law to the yaw angle tracking error signal to generate a yaw rate tracking error control signal, summing the yaw rate tracking error control signal and the nominal yaw rate signal to generate a yaw rate command signal, subtracting the sensed yaw rate signal from the yaw rate command signal to generate the yaw rate tracking error signal, and applying a fourth proportional-integral control law to the yaw rate tracking error signal to generate the moment tracking error control signal.

In another embodiment of the disclosed system, the program code may cause the system to generate the moment command signal by summing the nominal moment signal and the moment tracking error control signal.

In another embodiment of the disclosed system, the program code may cause the system to generate the nominal moment signal by using the nominal lateral force signal to compute a nominal sideslip angle signal based on the vessel's inverse force model, subtracting the nominal sideslip angle signal from the nominal heading angle signal and lowpass filtering the difference to generate a nominal yaw angle signal, pseudo-differentiating the nominal yaw angle signal to generate a nominal yaw rate signal, pseudo-differentiating the nominal yaw rate signal to generate a nominal yaw acceleration signal, and multiplying the nominal yaw acceleration signal by a rotational inertia of the marine surface vessel to generate the nominal moment signal.

In another embodiment of the disclosed system, the program code may cause the system to determine the nominal yaw angle signal by generating a nominal velocity signal based on the nominal position signal, generating a nominal yaw rate signal based on the nominal heading signal, generating a nominal force signal including a nominal surge component and a nominal sway component based on the nominal yaw rate signal and the nominal velocity signal, determining a required sway velocity to overcome the lateral drift based on the sway component of the nominal force signal and the vessel's force model parameters, generating a nominal sideslip signal based on a ratio of the required sway velocity to the surge component of the nominal velocity, and subtracting the nominal sideslip signal from the nominal heading signal to generate the nominal yaw angle signal.

In another embodiment of the disclosed system, the program code may cause the system to generate the nominal velocity signal by applying a second inverse translational kinematics function including the nominal heading signal as the coefficient of rotation to the pseudo-differentiated n-frame nominal position signal to generate the nominal b-frame velocity signal.

In another embodiment of the disclosed system, the program code may cause the system to generate the nominal yaw rate signal by pseudo-differentiating the nominal heading signal to generate the nominal yaw rate signal.

In another embodiment of the disclosed system, the marine surface vessel has a mass, and the program code may cause the system to generate the nominal force signal by pseudo-differentiating the nominal velocity signal to generate a nominal acceleration signal, applying a second inverse translational dynamics function including the nominal yaw rate signal as the coefficient of rotation to the nominal velocity signal to generate a result, subtracting the result from the nominal acceleration signal to generate a difference, and multiplying the difference by the mass of the marine surface vessel to generate the nominal force signal.

In another aspect of the invention, a computer program product is provided. The computer program product includes a non-transitory computer-readable storage medium, and program code stored on the non-transitory computer-readable storage medium. The program code is configured so that, when executed by one or more processors, the program code causes the one or more processors to receive a nominal position signal and a nominal heading signal each corresponding to a planned trajectory of the marine surface vessel in a navigation frame, generate a plurality of nominal control signals based on one or more of the nominal position signal and the nominal heading signal, the nominal control signals including a nominal force signal and a nominal moment signal, receive a plurality of sensed value signals including a sensed position signal, a sensed velocity signal, a sensed yaw angle signal, and a sensed yaw rate signal, generate a plurality of tracking error signals including a position tracking error signal generated based on the sensed position signal, a velocity tracking error signal generated based on the sensed velocity signal, a yaw angle tracking error signal generated based on the sensed yaw angle signal, and a yaw rate tracking error signal generated based on the sensed yaw rate signal, generate a plurality of tracking error control signals including a velocity tracking error control signal generated based on the position tracking error signal, a force tracking error control signal generated based on the velocity tracking error signal, a yaw tracking error control signal generated based on a sway component of the velocity tracking error signal, and a moment tracking error control signal generated based on the yaw rate tracking error signal, generate a plurality of command signals including a force command signal generated by summing the nominal force signal and the force tracking error control signal and a moment command signal generated by summing the nominal moment signal and the moment tracking error control signal, and control the one or more actuators of the marine surface vessel based on the force command signal and the moment command signal.

The above summary presents a simplified overview of some embodiments of the invention to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in the simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary model including a marine surface vessel, a navigation frame coordinate system, and a body-fixed frame coordinate system.

FIG. 2A is a diagrammatic view of the marine surface vessel of FIG. 1, and depicts actuators for propelling and steering the marine surface vessel.

FIG. 2B is schematic view of a trajectory linearization control based controller that produces a tracking command.

FIG. 3 is a tabular view of vessel parameters for the marine surface vessel of FIGS. 1 and 2.

FIG. 4 is a schematic view of a guidance control system for controlling the marine surface vessel of FIGS. 1 and 2.

FIG. 5A is a schematic view of a pseudo-differentiator that may be use by the guidance control system of FIG. 4.

FIG. 5B is a schematic view of an exemplary sub-controller that may be used to determine the nominal yaw angle.

FIG. 6 is a graphical view of exemplary open-loop trajectory tracking and actuator signals that may be generated by the guidance control system of FIG. 4.

FIGS. 7 and 8 are graphical views depicting command signals that produced the tracks of FIG. 6.

FIG. 9 is a graphical view of a two-dimensional trajectory in the navigation frame generated by a closed-loop controller for a circular test trajectory.

FIGS. 10-12 are graphical views showing sensed position tracking in the x-axis and y-axis, and sensed nominal yaw angle for the trajectory of FIG. 9.

FIGS. 13-15 are graphical views showing vessel speed for the u-axis, v-axis, and yaw rate for the trajectory of FIG. 9.

FIGS. 16-18 are graphical views showing actuator control signals and sideslip angle for the trajectory of FIG. 9.

FIGS. 18B-18G are graphical views showing vessel body to inertial frame pose errors for the trajectory of FIG. 9.

FIG. 19 is a graphical view of a two-dimensional trajectory in the navigation frame generated by a closed-loop controller for a sinusoidal test trajectory.

FIGS. 20-22 are graphical views showing sensed position tracking in the x-axis and y-axis, and sensed nominal yaw angle for the trajectory of FIG. 19.

FIGS. 23-25 are graphical views showing vessel speed for the u-axis, v-axis, and yaw rate for the trajectory of FIG. 19.

FIGS. 26-28 are graphical views showing actuator control signals and sideslip angle for the trajectory of FIG. 19.

FIGS. 28B-28G are graphical views showing vessel body to inertial frame pose errors for the trajectory of FIG. 19.

FIG. 29 is a tabular view of trajectory tracking errors for the simulation results depicted by FIGS. 9-28.

FIG. 30 is a diagrammatic view of an exemplary computer that may be used to implement one or more of the components or processes shown in FIGS. 4 and 5.

It should be understood that the appended drawings are not necessarily to scale, and may present a somewhat simplified representation of various features illustrative of the basic principles of the invention. The specific design features of the sequence of operations disclosed herein, including, for example, specific dimensions, orientations, locations, and shapes of various illustrated components, may be determined in part by the particular intended application and use environment. Certain features of the illustrated embodiments may have been enlarged or distorted relative to others to facilitate visualization and a clear understanding. In particular, thin features may be thickened, for example, for clarity or illustration.

### DETAILED DESCRIPTION

Embodiments of the present invention adapt a trajectory linearization control architecture to a three degrees of freedom marine surface vessel model. The marine surface vessel model is derived from the rigid body equations of motion to achieve a trajectory tracking objective with under-actuated two degrees of freedom control actuators. An exemplary approach implements a four-loop structure that simplifies controller design. This approach also separates the equations of motion into rigid-body, forces and moment, and actuator models. This streamlines the controller design as the generalized force components are handled in the control allocation. An exemplary embodiment of the open-loop nominal controller has been tested to demonstrate its ability to bring a marine surface vessel response close to the nominal trajectory. To overcome the under-actuation limitations, a novel approach to the allocation of the sway force to yaw control is also disclosed.

The marine surface vessel trajectory guidance control system disclosed herein improves tracking performance with significantly reduced design, development, deployment, and maintenance costs. Because the controller design is analytical in nature, it is scalable and tunable, and has a significantly reduce computational cost as compared to known systems. Embodiments of the present invention are applicable to marine surface vessels of different sizes and for different applications, such as transportation, scientific exploration, defense, and personal use. With suitable extension to six degrees of freedom, embodiments of the invention may also be used for submarine vessels.

Trajectory tracking is an aspect of motion control for surface vessels that is used for various applications such as autonomous transportation, defense, and scientific survey tasks. However, nonlinearities and uncertainties can arise during the motion control of marine vessels, making trajectory tracking a complex problem. To tackle this issue, embodiments of the present invention may employ a trajectory linearization control architecture to handle nonlinearities and uncertainties in vessel motion control.

Embodiments of the present invention are described in the context of a nonlinear three degrees of freedom rigid-body vessel model. The disclosed guidance control system uses a multi-nested loop trajectory linearization control architecture, and includes an open-loop nominal controller and a closed-loop tracking error controller to achieve integrated motion control of the marine surface vessel. Particular emphasis may be made on the design and tuning of the open-loop nominal controller. This is typically lacking in vessel control applications of trajectory linearization, and in particular for marine surface vessels. Under-actuation may be overcome by assigning sway control to the yaw motion control sub-system. In one embodiment, the guidance control system is divided into four loops that ease the design process. The stability of the overall system may be achieved using the time scale separation principle since each of the individual loops is exponentially stabilized by the tracking error controller corresponding to the loop in question. Simulation results based on a CyberShip II scale model vessel demonstrate that the proposed approach provides satisfactory tracking of a circular trajectory. Overall, the proposed approach effectively addresses the trajectory tracking problem for under-actuated marine surface vessels.

The below disclosure is organized into Vessel Modeling, Controller Design, and Simulation Results sections. In the Vessel Modeling section, assumptions have been made to reduce the general six degrees of freedom rigid body model to a three degrees of freedom kinematic and dynamic model of the marine surface vessel. The Vessel Modeling section also describes the generalized forces that act on the marine surface vessel, the interactions that cause them, and an actuator model. The actuator model subsection discloses the corresponding force model equations and the dynamics model of the actuators. The controller design section describes the design of different open-loop nominal and closed-loop feedback modules for the translational and rotational kinematics and dynamics loops of the marine surface vessel model, as well as the control allocation of the command signals. A separate subsection is dedicated to the tuning of the open-loop nominal controller. The Simulation Results section discloses a test case scenario using the parameter values of a sub-scale model vessel for the proposed guidance control system.

### I. Vessel Modeling

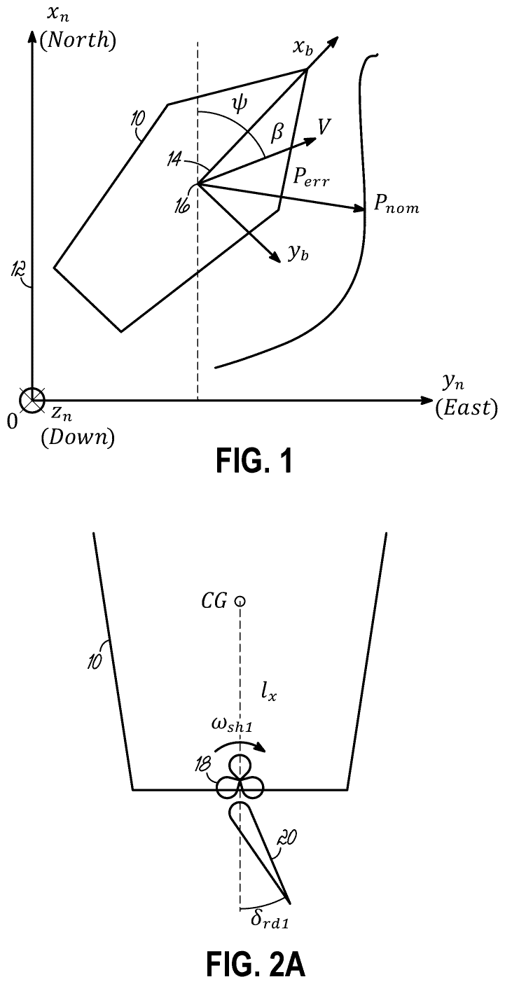

The below described marine surface vessel model is derived by applying the laws of physics to a rigid body. FIG. 1 depicts an exemplary marine surface vessel 10, a navigation frame (n-frame) coordinate system 12, and a body-fixed frame (b-frame) coordinate system 14. The marine surface vessel kinematic and dynamic equations are determined relative to the n-frame and b-frame. The n-frame follows the North-East-Down (NED) convention, where the xₙ-axis points to the North, the yₙ-axis points to the East and the zₙ-axis points downward. The b-frame coordinate system 14 has an origin at the center of gravity 16 of the vessel, with the x_{b}-axis pointing toward the bow, the y_{b}-axis pointing toward the starboard side, and the z_{b}-axis pointing toward the bottom of the hull.

This modeling method produces a six degrees of freedom model of surface vessel kinematics and dynamics. However, the following assumptions may be made to reduce the model to three degrees of freedom, thereby facilitating the design of a baseline guidance control system. These assumptions include: (1) a flat and inertial earth, (2) no rotation about the x_{b}-axis (rolling), no motion along the z_{b}-axis (heaving), no rotation about the y_{b}-axis (pitching), (3) the center of gravity and the center of buoyancy are co-located vertically on the z_{b}-axis, (4) xz-plane symmetry, and (5) calm water and the absence of wind. Thus, the only movement included in the three degrees of freedom model is linear motion in the x_{b}-axis (surge), linear motion in the y_{b}-axis (sway), and rotation about the z_{b}-axis (yaw).

The resulting three degrees of freedom marine surface vessel model may be represented by the following Equations of motion:

### Rigid-Body Model

### Translational Kinematics

$$[ \begin{matrix}\dot{x} \\ \dot{y}\end{matrix} ] = [ \begin{matrix}cos ( ψ ) & - sin ( ψ ) \\ sin ( ψ ) & cos ( ψ )\end{matrix} ] [ \begin{matrix}u \\ v\end{matrix} ] \qquad Eqn . 1$$

### Translational Dynamics

$$[ \begin{matrix}\dot{u} \\ \dot{v}\end{matrix} ] = [ \begin{matrix}0 & r \\ - r & 0\end{matrix} ] [ \begin{matrix}u \\ v\end{matrix} ] + \frac{1}{m} [ F ] \qquad Eqn . 2$$

### Rotational Kinematics

$$\dot{ψ} = r \qquad Eqn . 3$$

### Rotational Dynamics

$$\dot{r} = \frac{1}{{I}_{z}} {N}_{m} \qquad Eqn . 4$$

Equation 1 may be referred to as the translational kinematics function, and defines the translational kinematics of a rigid body, e.g., between velocity [u v]^{T} in the body frame and velocity [\dot{x} \dot{y}]^{T} in the n-frame. Equation 2 may be referred to as the translational dynamics function, and defines the translational dynamics of the rigid body. Equation 3 may be referred to as the rotational kinematics function, and defines the rotational kinematics of the rigid body. Equation 4 may be referred to as the rotational dynamics function, and defines the rotational dynamics of the rigid body. In the above Equations, ψ is the angular offset of the b-frame from the n-frame (yaw angle), u is the velocity of the vessel along the x_{b}-axis, v is the velocity of the vessel along the y_{b}-axis, m is the mass of the vessel, r is the rotational velocity of the vessel (yaw rate), I_{z} is the rotational inertia of the vessel about the z_{b}-axis, and Nₘ is the moment of force about the z_{b}-axis.

### Force and Moment Models

The force vector F in Equation 2 may be composed of the following terms:

$$F = [ \begin{matrix}{F}_{x} \\ {F}_{y}\end{matrix} ] = {F}_{H} + {F}_{D} + {F}_{C} + {F}_{w} \qquad Eqn . 5$$

where F_{H} represents a hydrodynamic force due to the added masses resulting from the interaction of the vessel hull with the surrounding fluid, F_{D} represents the damping forces resulting from skin friction, vortex shedding, and fluid drag, F_{C} represents the force vector generated by the actuators, and F_{w} represents the disturbance forces due to wind and waves. The hydrodynamic force F_{H} and damping force F_{D} may be provided by Equations 6 and 7, below:

$${F}_{H} = [ \begin{matrix}{X}_{\dot{u}} \dot{u} \\ {Y}_{\dot{v}} \dot{v} + {Y}_{\dot{r}} \dot{r}\end{matrix} ] - [ \begin{matrix}{Y}_{\dot{v}} vr + {Y}_{\dot{r}} {r}^{2} \\ {X}_{\dot{u}} ur\end{matrix} ] \qquad Eqn . 6$$

$${F}_{D} = [ \begin{matrix}{X}_{u} u + {X}_{\vert u \vert u} \vert u \vert u + {X}_{uuu} {u}^{3} \\ {Y}_{v} v + {Y}_{r} r + {Y}_{\vert v \vert v} \vert v \vert v + {Y}_{\vert r \vert v} \vert r \vert v + {Y}_{\vert v \vert r} \vert v \vert r + {Y}_{\vert r \vert r} \vert r \vert r\end{matrix} ] \qquad Eqn . 7$$

The moment of force (“moment”) Nₘ in Equation 4 may include the following terms:

$${N}_{m} = {N}_{CR} + {N}_{H} + {N}_{D} + {N}_{C} + {N}_{w} \qquad Eqn . 8$$

where N_{CR} is the moment due the Coriolis and centripetal effects (which equals zero when the b-frame origin and center of gravity are co-located), N_{H} is the hydrodynamic moment due to added mass, N_{D} is the damping moment, N_{C} is the control moment produced by the actuators, and N_{w} is the disturbance due to wind and waves. The N_{H} and N_{D} moments may be described by the following Equations:

$${N}_{H} = {Y}_{\dot{r}} \dot{v} + {N}_{\dot{r}} \dot{r} + {Y}_{\dot{v}} uv - {Y}_{\dot{r}} ur - {X}_{\dot{u}} uv \qquad Eqn . 9$$

$${N}_{D} = {N}_{v} v + {N}_{r} r + {N}_{\vert v \vert v} \vert v \vert v + {N}_{\vert r \vert v} \vert r \vert v + {N}_{\vert v \vert r} \vert v \vert r + {N}_{\vert r \vert r} \vert r \vert r \qquad Eqn . 10$$

In Equations 6, 7, 9, and 10, X_{*}, Y_{*} and N_{*} are the hydrodynamic derivatives in the surge, sway, and yaw directions, respectively, and the derivatives X_{\dot{u}}, Y_{\dot{u}} and N_{\dot{r}} are the added masses resulting from the interaction of the vessel's hull with water.

### Actuator Model

The actuator model is taken from a sub-scale marine surface vessel known as CyberShip II, which is described in detail by R. e. a. Skjetne, “Adaptive maneuvering, with experiments, for a model ship in a marine control laboratory,” Automatica, vol. 44, pp. 289-298, February 2005. The vessel in Skjetne is originally equipped with a pair of propeller-rudder propulsion systems, located aft of the vessel equidistant from the center line of the vessel.

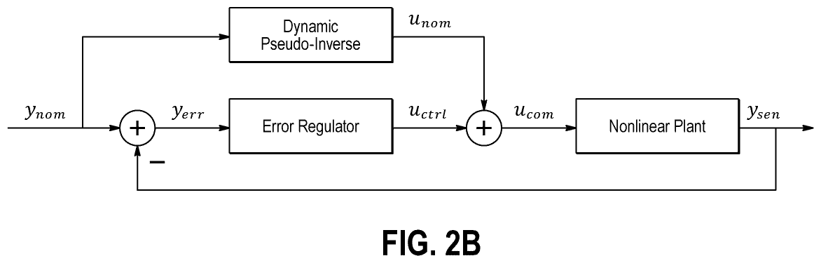

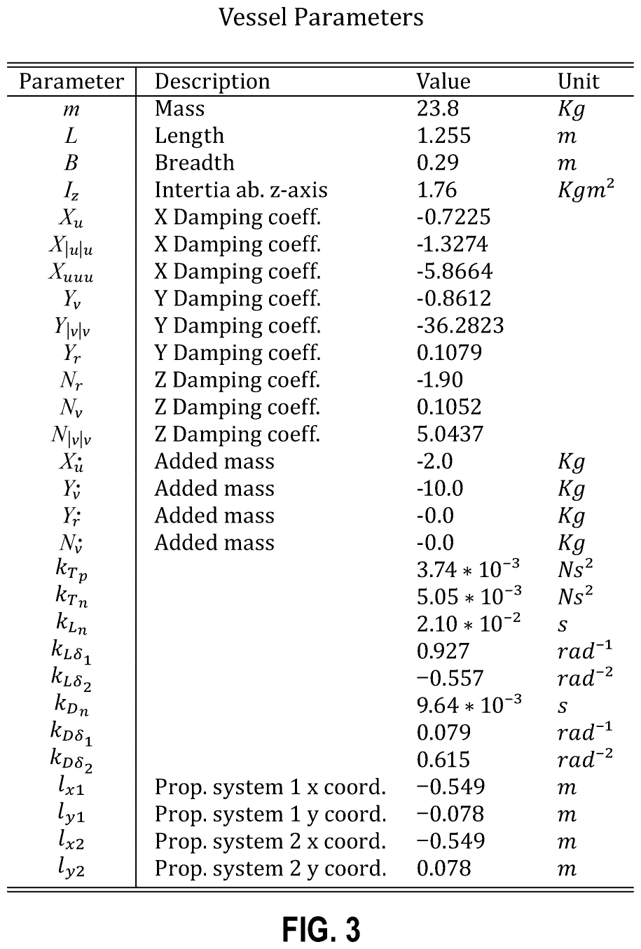

FIG. 2 depicts a surface vessel 10 including a single propeller 18 and rudder 20 to which the disclosed control systems may be applied without loss of generality. The same control effect can be achieved by doubling the control derivatives of the two propeller-rudder system, except that the dual-actuator configuration allows for yaw control by differential thrust. However, the control effectiveness is typically negligible as compared to that of the rudders. Differential thrust may therefore only be useful for very low speed maneuvering, and can generally be ignored. The thrust ( [symbol] ), rudder drag ( [symbol] ) and transversal lift force of the rudder ( [symbol] ) exerted on the marine surface vessel by the one propeller-rudder configuration may be functions of the propeller shaft angular velocity ωₛₕ and the rudder angle δ_{rd}. These functions are given by the following Equations:

$$𝒯 ( {ω}_{sh} , {δ}_{rd} ) = \{ \begin{matrix}{k}_{{𝒯}_{p}} {ω}_{sh}^{2} & {ω}_{sh}^{2} \geq 0 \\ {k}_{{𝒯}_{n}} \vert {ω}_{sh} \vert {ω}_{sh} & {ω}_{sh}^{2} < 0\end{matrix} \qquad Eqn . 11$$

$$𝒟 ( {ω}_{sh} , {δ}_{rd} ) = \{ \begin{matrix}𝒯 ( 1 + {k}_{{𝒟}_{n}} {ω}_{sh} ) ( {k}_{{𝒟δ}_{1}} \vert {δ}_{rd} \vert ) & {ω}_{sh}^{2} \geq 0 \\ 0 & {ω}_{sh}^{2} < 0\end{matrix} \qquad Eqn . 12$$

$$ℒ ( {ω}_{sh} , {δ}_{rd} ) = \{ \begin{matrix}𝒯 ( 1 + {k}_{{ℒ}_{n}} {ω}_{sh} ) ( {k}_{{ℒδ}_{1}} \vert {δ}_{rd} \vert ) & {ω}_{sh}^{2} \geq 0 \\ 0 & {ω}_{sh}^{2} < 0\end{matrix} \qquad Eqn . 13$$

where [symbol] and [symbol] are the thrust of the propeller for forward and reverse motion respectively, [symbol] and [symbol] are the drag coefficients of the rudder, and [symbol] and [symbol] are the lift coefficients of the rudder. These coefficients, doubled for one actuator, are depicted in FIG. 3. Equations 11-13 are given in the actuator reference frame parallel to the b-frame, whose origin is at (lₓ, 0) with respect to the origin of the b-frame. The resulting force vector in the surge and sway directions is given by Equation 14:

$$[ \begin{matrix}{F}_{C , x} \\ {F}_{C , y} \\ {N}_{C}\end{matrix} ] = [ \begin{matrix}𝒯 - 𝒟 \\ ℒ \\ ℒ {l}_{x}\end{matrix} ] \qquad Eqn . 14$$

The actuator dynamics model presumes that for the sub-scale marine surface vessel, the propeller and rudder actuators are, respectively, DC motors and DC servo motors. These motors may be modeled as second order transfer functions of the form:

$${G}_{act} ( s ) = \frac{{ω}_{n , act}^{2}}{{s}^{2} + 2 {ζ}_{act} {ω}_{n , act} s + {ω}_{n , act}^{2}} \qquad Eqn . 15 a$$

For simplicity, the propeller and rudder actuators may be modeled, respectively, as second order transfer functions of the form:

$${G}_{sh} ( s ) = \frac{{ω}_{n , sh}^{2}}{{s}^{2} + 2 {ζ}_{sh} {ω}_{n , sh} s + {ω}_{n , sh}^{2}} \qquad Eqn . 15 b$$

$${G}_{rd} ( s ) = \frac{{ω}_{n , rd}^{2}}{{s}^{2} + 2 {ζ}_{rd} {ω}_{n , rd} s + {ω}_{n , rd}^{2}} \qquad Eqn . 15 c$$

### II. Control System Design

The trajectory linearization control architecture is composed of two controllers, namely an open-loop nominal controller and a closed-loop feedback controller. The nominal controller is design and constructed via dynamic pseudo-inversion of the vessel model. The feedback controller regulates the error dynamics and achieves exponential stability. FIG. 2B depicts a trajectory linearization control based controller that produces a tracking command u_{com} which is the sum of the b-frame nominal velocity component uₙₒₘ and the b-frame velocity tracking error control component u_{ctrl}.

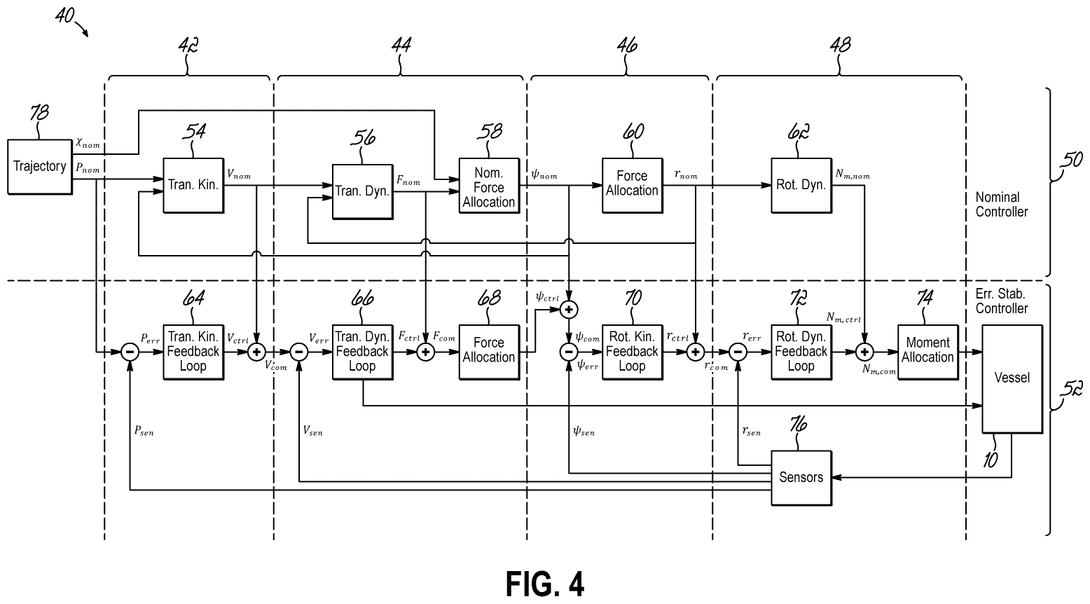

The overall marine surface vessel controller design is simplified by the cascade of the three degrees of freedom marine surface vessel into subsystems. This structure may be referred to as a multi-nested loop trajectory linearization controller. The basic trajectory linearization controller structure depicted by FIG. 2B may be applied to each subsystem. Exponential stability of the overall system may be achieved one subsystem at a time by the time scale separation principle. FIG. 4 depicts an exemplary multi-nested loop trajectory linearization controller. In an embodiment of the present invention, the control algorithm may be realized under the following three assumptions. The first assumption is that a feasible nominal pose trajectory θₙₒₘ(t)=[xₙₒₘ(t), yₙₒₘ(t), ψₙₒₘ(t)]^{T} is provided by an external trajectory planner. Due to the multi-nested loop partition, the translational position may be represented as P(t)=[x(t), y(t)]^{T} in the below disclosure. The second assumption is that the nominal trajectory θₙₒₘ∈C². The third assumption is that all motion states θₙₒₘ(t)=[xₙₒₘ(t), yₙₒₘ(t), ψₙₒₘ(t)]^{T} are directly measurable.

The approach of the disclosed guidance control system design includes generating a command signal *_{com} for each state variable in which the command signal *_{com} includes an open-loop nominal component *ₙₒₘ and a system stabilizing closed-loop tracking error control component *_{ctrl}, i.e., *_{com}=*ₙₒₘ+*_{ctrl}. The nominal control signals may be obtained by nonlinear dynamic pseudo-inversion of the vessel model, which takes the system response close to the nominal trajectory. The nonlinear time-varying tracking error dynamics may then be linearized along the nominal trajectory. Exponential stabilization of the error dynamics is effectively achieved by the implementation of a closed-loop tracking error controller with linear time-varying feedback controller gains. The tracking error controller produces the stabilizing tracking error control component of the command signal. This way, the domain of attraction of the tracking error dynamics is maximized as compared to controllers that are linearized at fixed operating points and stabilized by gain scheduling.

The guidance control system design is further simplified by partitioning the marine surface vessel model into four nested loops: two translational loops and two rotational loops, per the Equations of motion 1-4. This structure is referred to herein as a multi-nested loop trajectory linearization control architecture. The stability of the overall system is achieved by the time scale separation principle since each of the individual loops is exponentially stabilized by a closed-loop feedback module, such that the bandwidth of an outer loop may be limited by at least a factor of ⅓ of its inner loop bandwidth. The bandwidth of an outer loop may be limited by at least a factor of ⅓ of its inner loop bandwidth based on the singular perturbation (time-scale separation) theory. As a consequence, the complexity of the controller design required for each feedback loop is reduced.

FIG. 4 depicts an exemplary multi-nested loop trajectory linearization guidance control system 40 which may be used to control the marine surface vessel 10 of FIGS. 1 and 2. The guidance control system 40 includes a translational kinetics loop 42, a translational dynamics loop 44, a rotational kinetics loop 46, and a rotational dynamics loop 48. The upper portion of each loop may collectively define an open-loop nominal controller 50 of guidance control system 40, and the lower portion of each loop may collectively define a closed-loop tracking error controller 52 of guidance control system 40. In the below description of the guidance control system 40, the subscript sen may be used to identify sensed value signals (such as a sensed position signal Pₛₑₙ), the subscript nom may be used to identify nominal control signals (i.e., the open loop control signals determined from the planned trajectory, such as a nominal velocity signal Vₙₒₘ), the subscript err may be used to identify tracking error signals (such as a position tracking error signal Pₑᵣᵣ), the subscript ctrl may be used to identify tracking error control signals (such as a velocity tracking error control signal V_{ctrl}), and the subscript com may be used to identify command signals (such as a force command signal F_{com}). Command signals may be generated by adding tracking error control signals to their respective nominal control signals.

The nominal controller 50 may include a plurality of open-loop nominal control modules, e.g., a translational kinematics module 54, a translational dynamics module 56, a nominal force allocation module 58, a rotational kinematics module 60, and a rotational dynamics module 62. Each of the nominal control modules 54, 56, 58, 60, 62 may generate a respective nominal control signal. The nominal control signals may include a nominal position signal Pₙₒₘ, a nominal velocity signal Vₙₒₘ, a nominal force signal Fₙₒₘ, a nominal yaw angle signal ψₙₒₘ, a nominal yaw rate signal rₙₒₘ, and a nominal moment signal N_{m,nom}. One or more of these signals may include a surge component (which may also be referred to as a longitudinal component) and a sway component (which may also be referred to as a lateral component).

The tracking error controller 52 of guidance control system 40 may include a plurality of closed-loop feedback modules, e.g., a translational kinematics feedback module 64, a translational dynamics feedback module 66, a force allocation module 68, a rotational kinematics feedback module 70, a rotational dynamics feedback module 72, and a moment allocation module 74. Each of the feedback modules 64, 66, 68, 70, 72 may be associated with a corresponding one of the plurality of nominal control modules 54, 56, 58, 60, 62, and may generate a respective tracking error control signal *_{ctrl}. A moment allocation module 74 may receive the moment command signal N_{m,com} and provide command signals to the vessel actuators, e.g., the propulsion system and rudder.

A vessel sensor system 76 may provide a sensed position Pₛₑₙ, sensed velocity signal Vₛₑₙ, sensed yaw angle signal ψₛₑₙ, and sensed yaw rate signal rₛₑₙ to the guidance control system 40. To determine these sensed values, the vessel sensor system 76 may use one or more of a Global Positioning System (GPS), inertial measurement unit (IMU), or any other suitable sensors configured to detect the position, orientation, and movement of the surface vessel.

A trajectory planner 78 may provide a nominal position signal Pₙₒₘ and a nominal heading signal χₙₒₘ to one or more of the translational kinematics module 54, nominal force allocation module 58, and translational kinematics feedback module 64. The translational kinematics module 54 may generate a nominal velocity signal Vₙₒₘ based on the nominal position signal Pₙₒₘ. and nominal yaw angle signal ψₙₒₘ. A difference between the nominal position signal Pₙₒₘ and sensed position Pₛₑₙ may be determined to generate a position tracking error signal Pₑᵣᵣ, e.g., Pₑᵣᵣ=Pₙₒₘ−Pₛₑₙ. The position tracking error signal Pₑᵣᵣ may be provided to the translational kinematics feedback module 64, which may generate a velocity tracking error control signal V_{ctrl} based thereon.

The nominal velocity signal Vₙₒₘ and nominal yaw rate signal rₙₒₘ may be provided to the translational dynamics module 56, which may generate a nominal force signal Fₙₒₘ based thereon. The nominal velocity signal Vₙₒₘ may also be summed with the velocity tracking error control signal V_{ctrl} to generate a velocity command signal V_{com}. A difference between the velocity command signal V_{com} and sensed velocity signal Vₛₑₙ may be determined to define a velocity tracking error signal Vₑᵣᵣ., e.g., Vₑᵣᵣ=V_{com}−Vₛₑₙ. The velocity tracking error signal Vₑᵣᵣ may be provided to the translational dynamics feedback module 66, which may generate a force tracking error control signal F_{ctrl} based thereon.

The nominal force signal Fₙₒₘ may be provided to the nominal force allocation module 58. The nominal force allocation module 58 may generate a nominal yaw angle signal ψₙₒₘ based on the nominal force signal Fₙₒₘ and nominal heading signal χₙₒₘ. The nominal yaw angle signal ψₙₒₘ may be determined from the nominal force signal [F_{x,nom}, F_{y,nom}]^{T} as ψₙₒₘ=tan⁻¹(F_{y,nom}/F_{x,nom}) for F_{x,nom}>0, and ψₙₒₘ=tan⁻¹(F_{y,nom}/F_{x,nom}+π) for F_{x,nom}<0. The nominal force signal Fₙₒₘ may also be summed with the force tracking error control signal F_{ctrl} to generate a force command signal F_{com}. The force command signal F_{com} may be provided to the force allocation module 68, which may generate a yaw tracking error control signal ψ_{ctrl} based thereon, e.g., ψ_{ctrl}=tan⁻¹(F_{y,com}/F_{x,com}) for F_{x,com}>0, and ψ_{ctrl}=tan⁻¹(F_{y,com}/F_{x,com}+π) for F_{x,com}<0. The yaw tracking error control signal ψ_{ctrl} may be added to the nominal yaw angle signal ψₙₒₘ to generate a yaw angle command signal ψ_{com}. A difference between the yaw angle command signal ψ_{com} and sensed yaw signal ψₛₑₙ may be determined to define a yaw angle tracking error signal ψₑᵣᵣ, e.g., ψₑᵣᵣ=ψ_{com}−ψₛₑₙ. The yaw angle tracking error signal ψₑᵣᵣ may be provided to the rotational kinematics feedback module 70, which may generate a yaw rate tracking error control signal r_{ctrl}. In each case, F_{x,*} may be referred to as a “longitudinal” or “surge” force signal and Fy, * may be referred to as a “lateral” or “sway” force signal. Thus, each of the above signals may comprise a surge component and a sway component.

The nominal yaw angle signal ψₙₒₘ may be provided to the rotational kinematics module 60, which may generate a nominal yaw rate signal rₙₒₘ based thereon. The nominal yaw rate signal rₙₒₘ may be summed with the yaw rate tracking error control signal r_{ctrl} to generate a yaw rate command signal r_{com}. A difference between the yaw rate command signal rcom and sensed yaw rate signal rₛₑₙ may be determined to define a yaw rate tracking error signal rₑᵣᵣ, e.g., rₑᵣᵣ=r_{com}−rₛₑₙ. The yaw rate tracking error signal rₑᵣᵣ may be provided to the rotational dynamics feedback module 72, which may generate a moment tracking error control signal N_{m,ctrl} based thereon.

The nominal yaw angle signal ψₙₒₘ may also be provided to the rotational dynamics module 62, which may generate a nominal moment signal N_{m,nom} based thereon. The nominal moment signal N_{m,nom} and moment tracking error control signal N_{m,ctrl} may be summed to generate the moment command signal N_{m,com}. The force command signal F_{com} and moment command signal N_{m,com} may be provided to the moment allocation module 74, which may generate control signals for controlling one or more of the propeller shaft angular velocity ωₛₕ and the rudder angle δ_{rd} of the surface vessel 10.

### Nominal Controller Design

As described above with respect to FIG. 4, the nominal controller 50 may generate nominal control signals for each of the guidance control system loops 42, 44, 46, 48. The nominal control signals may be generated using a psuedo-dynamic inversions of Equations 1-4. Accordingly, the nominal control signals may be provided by the following Equations:

$${V}_{nom} = {[ \begin{matrix}cos ( {ψ}_{nom} ) & - sin ( {ψ}_{nom} ) \\ sin ( {ψ}_{nom} ) & cos ( {ψ}_{nom} )\end{matrix} ]}^{- 1} {nom}_{} \qquad Eqn . 16$$

$$[ \begin{matrix}{F}_{x , nom} \\ {F}_{y , nom}\end{matrix} ] = m [ \begin{matrix}{nom}_{} \\ {nom}_{}\end{matrix} ] - m [ \begin{matrix}0 & {r}_{nom} \\ - {r}_{nom} & 0\end{matrix} ] [ \begin{matrix}{u}_{nom} \\ {v}_{nom}\end{matrix} ] \qquad Eqn . 17$$

$${ψ}_{nom} = {χ}_{nom} - {β}_{nom} \qquad Eqn . 18$$

$${r}_{nom} = {nom}_{} \qquad Eqn . 19$$

$${N}_{m , nom} = \qquad Eqn . 20$$

where * denotes a variable, \hat{*} denotes the low-pass filtered variable *, and [symbol] denotes a derivative of the low-pass filtered variable \hat{*}. Thus, \hat{P}ₙₒₘ may be referred to as the filtered nominal position signal, [symbol] ₙₒₘ may be referred to as the differential filtered nominal position signal, \hat{ψ}ₙₒₘ may be referred to as the filtered nominal yaw angle signal, [symbol] ₙₒₘ may be referred to as the differential filtered nominal yaw angle signal, \hat{r}ₙₒₘ may be referred to as the filtered nominal yaw rate signal, and [symbol] ₙₒₘ may be referred to as the differential filtered nominal yaw rate signal. Equation 16 may be referred to as the inverse translational kinematics function and, as depicted, includes the nominal yaw angle ψₙₒₘ as a coefficient of rotation. Equation 17 may be referred to as the inverse translational dynamics function and, as depicted, includes the nominal yaw rate rₙₒₘ as a coefficient of rotation. Equation 19 may be referred to as the inverse rotational kinematics function, and Equation 20 may be referred to as the inverse rotational dynamics function.

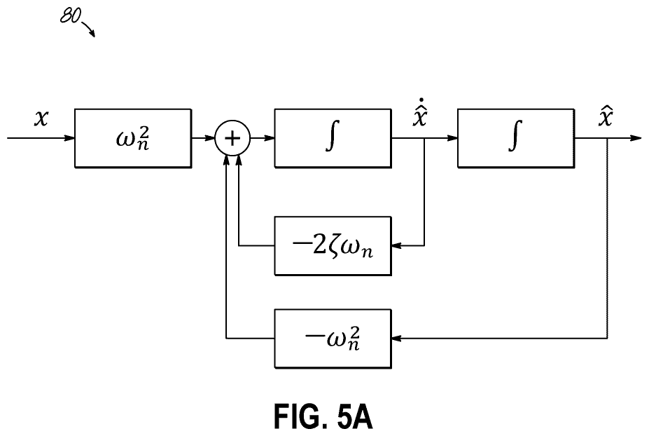

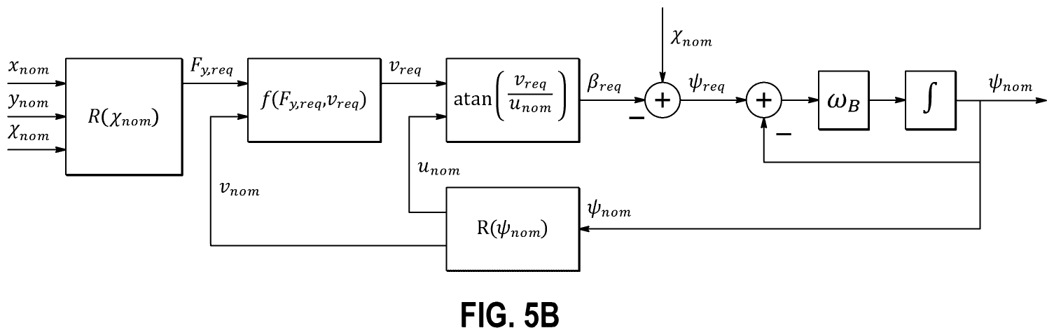

FIG. 5A depicts an exemplary pseudo-differentiator 80 that may be used to obtain differential filtered variables. A pseudo-differentiator may be needed due to the exact derivative operation being anticausal, and thus not realizable in real-time operations. The depicted pseudo-differentiator 80 may also allow for a desired dynamics of the nominal variables to be designed by selecting the values of ζ_{diff} and ω_{n,diff}. By way of example, the pseudo-differentiator 80 may take the form:

$${G}_{diff} ( s ) = \frac{{ω}_{n , diff}^{2} s}{{s}^{2} + 2 {ζ}_{diff} {ω}_{n , diff} s + {ω}_{n , diff}^{2}} \qquad Eqn . 21 a$$

where G_{diff}(s) is the low-pass filtered pseudo differential of s. Viewed another way,

$$[ \begin{matrix} \\ \end{matrix} ] = [ \begin{matrix}0 & 1 \\ - {ω}_{n , diff}^{2} & - 2 {ζ}_{diff} {ω}_{n , diff}\end{matrix} ] [ \begin{matrix}\hat{*} \\ \end{matrix} ] + [ \begin{matrix}0 \\ {ω}_{n , diff}^{2}\end{matrix} ] \qquad Eqn . 21 b$$

where \hat{*} and [symbol] denote the lowpass filtered variable and its derivative, respectively.

A static inverse may be obtained by eliminating the pseudo-derivatives in Equations 17-20. Such a static inverse can be used in path-following control and determining steady-state trim controls. It may be noted that the nominal yaw angle signal ψₙₒₘ may be determined as the difference between the nominal heading signal χₙₒₘ and a nominal sideslip angle signal from βₙₒₘ(ψₙₒₘ=χₙₒₘ−βₙₒₘ), where the nominal heading signal Xₙₒₘ is provided by the trajectory planner 78. The nominal sideslip angle signal βₙₒₘ may be computed from a reference vessel inverse with the reference pose trajectory [xₙₒₘ, yₙₒₘ, χₙₒₘ] from the trajectory planner as follows.

As shown by Equation 22 below, a nominal velocity Vₙₒₘ may be determined by low-pass filtering the position reference signal Pₙₒₘ to generate a low-pass filtered position reference signal \hat{P}ₙₒₘ. The low-pass filtered position reference signal \hat{P}ₙₒₘ may be differentiated to generate a differential filtered nominal position signal [symbol] ₙₒₘ. These steps may be performed concurrently, e.g., by pseudo-differentiator 80, such that differential filtered nominal position signal [symbol] ₙₒₘ is produced, e.g., as depicted by FIG. 5A. An inverse translational dynamics function including the nominal heading signal χₙₒₘ as a coefficient of rotation may then be applied to the differential filtered nominal position signal [symbol] ₙₒₘ to generate the nominal velocity signal Vₙₒₘ.

The longitudinal force and torque commanded to the actuators may be calculated by inversion of Equations 5 and 8 to produce Equations 21c and 21d.

$${F}_{Cx ; com} = {F}_{x , nom} - {F}_{H , xnom} - {F}_{D , xnom} \qquad Eqn . 21 c$$

$${N}_{C , com} = {N}_{nom} - {N}_{H , nom} - {N}_{D , nom} \qquad Eqn . 21 d$$

The lateral force F_{y} may be controlled by using the nominal sideslip angle βₙₒₘ as a virtual control effector with the directional loop as the actuator. FIG. 5B depicts an exemplary algorithm that may implemented in block 58 of the guidance system controller 40 to determine the nominal yaw angle signal ψₙₒₘ. The nominal sideslip angle βₙₒₘ may be determined from the nominal pose trajectory ηₙₒₘ(t) once the nominal yaw angle signal ψₙₒₘ is known. The required lateral force F_{y,req} may calculated from the nominal pose trajectory ηₙₒₘ using Equations 22-24 below:

$${V}_{req} = [ \begin{matrix}{u}_{req} \\ {v}_{req}\end{matrix} ] = {[ \begin{matrix}cos ( {χ}_{req} ) & - sin ( {χ}_{req} ) \\ sin ( {χ}_{req} ) & cos ( {χ}_{req} )\end{matrix} ]}^{- 1} {req}_{} \qquad Eqn . 22$$

A required yaw rate signal r_{req} may be generated by low-pass filtering the required heading signal χ_{req} to generate a low-pass filtered required heading signal \hat{χ}_{req}, and differentiating the filtered required heading signal \hat{χ}_{req} to generate a differential filtered required heading signal [symbol] _{req} as shown by Equation 23.

$${r}_{req} = {req}_{} \qquad Eqn . 23$$

An inverse translational dynamics function including the required yaw rate signal r_{req} as a coefficient of rotation may be applied to the nominal velocity signal V_{req}, and the result subtracted from a differential filtered nominal velocity signal [symbol] _{req}. This difference may be multiplied by the mass m of the marine surface vessel 10 to generate the required force signal F_{req} as shown by Equation 24a including a nominal surge component F_{x,nom} and a nominal sway component F_{y,nom}.

$$[ \begin{matrix}{F}_{x , req} \\ {F}_{y , req}\end{matrix} ] = - m [ \begin{matrix}0 & {r}_{req} \\ - {r}_{req} & 0\end{matrix} ] {V}_{req} \qquad Eqn . 24$$

The required lateral velocity v_{req} may be approximated from the required sway force F_{y,req} with the most significant coefficients Y_{|v|v} and Yᵥ. The required velocity v_{req} may then be determined by:

$${v}_{req} = sign ( {v}_{nom} ) ( \frac{- {Y}_{v} + \sqrt{{Y}_{v}^{2} + p}}{2 {Y}_{\vert v \vert v}} ) \qquad Eqn . 25 a$$

$$p = \{ \begin{matrix}4 {F}_{y , req} {Y}_{\vert v \vert v} sign ( {v}_{nom} ) & sign ( {F}_{y , req} ) \neq sign ( {v}_{nom} ) \\ 0 & otherwise\end{matrix} \qquad Eqn . 25 b$$

where:
Equation 25a presents the erroneous condition sign(F_{y,req})=sign(vₙₒₘ) that may be caused by approximation errors as vₙₒₘ→0.

The required sideslip angle β_{req} may then be calculated using the required velocity v_{req} from Equation 25a and u_{req} by the approximation:

$${β}_{req} ( t ) = \frac{{v}_{req} ( t )}{{u}_{req} ( t )} \qquad Eqn . 26$$

The required sideslip angle β_{req} may then be used to compute the required heading angle χ_{req} using Equation 24e:

$${ψ}_{req} = {χ}_{req} - {β}_{req} \qquad Eqn . 27$$

The required yaw angle ψ_{req} may then be used to determine the rate of change of the nominal yaw angle:

$${\dot{ψ}}_{nom} ( t ) = {ω}_{B} ( {ψ}_{req} ( t ) - {ψ}_{nom} ( t ) ) \qquad Eqn . 28$$

where ω_{B} is a design parameter.

Strict assumptions of constant sideslip angle β and constant generalized velocities for a trajectory comprising straight lines and circular segments may be eliminated in the present approach, so long as the nominal trajectory is smooth according to Assumptions 1-2.

The above “required” signals *_{req} only arise in the nominal sideslip βₙₒₘ and nominal heading angle ψₙₒₘ computation, as shown in FIG. 5B, due to an intermediate step between the reference and nominal signals. Since the trajectory designer is not concerned with the dynamics of the vessel, at this stage the nominal heading angle ψₙₒₘ=χₙₒₘ, and nominal sideslip angle βₙₒₘ=0. If the nominal trajectory calls for a turn, a centrifugal force will be generated due to the coupling of the lateral and rotational dynamics, which will cause the vessel to drift off course. This drift can be overcome by steering the vessel to create a sideslip angle, which in turn will generate a hydrodynamic centripetal force to cancel the centrifugal force. The required sideslip angle is computed by inverting the required side force model, which is then added to the nominal course angle χₙₒₘ to compute the required vessel heading angle ψ_{req}. Then the current nominal heading angle is updated to the new required heading angle ψ_{req} via a smoothing lowpass filter. Essentially, the required variables are computed offline from the nominal signals and then used to update the online nominal signals.

### Nominal Controller Tuning

Improved open-loop performance may lead to increased stability margins and less corrective actuator activities in the closed-loop controller. It may therefore be advantageous to tune the nominal controller 50 to optimize open-loop performance. The tuning of the nominal controller 50 may be done in such a way that the module being tuned has a fast enough response to avoid producing an excessive lag to its outer loop motion, but not so fast as to demand an excessive response from its inner loop. To this end, the time-scale separation principle may be applied considering the rotational dynamics of the innermost loop and assigned the fastest response. As a starting point, subsequent modules may be assigned a dynamic response one third as fast as the previous module.

The translational kinematic module 54 may need to have enough bandwidth to accommodate the highest expected frequency (curvature) in the desired translational motion. A good rule of thumb may be to assign a bandwidth ten times higher than the expected motion bandwidth.

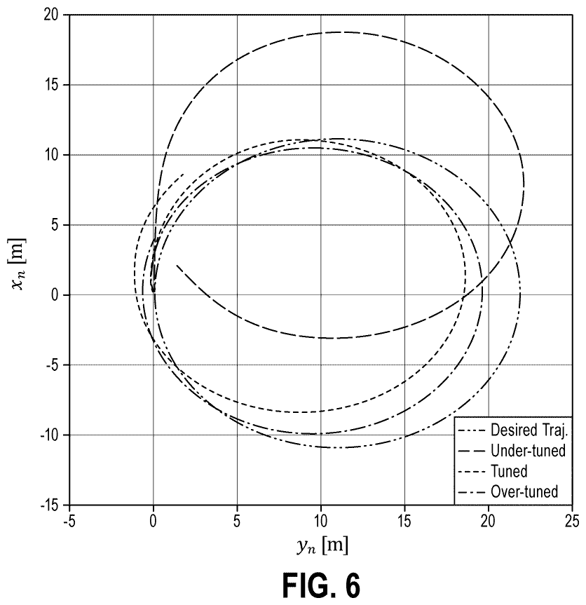

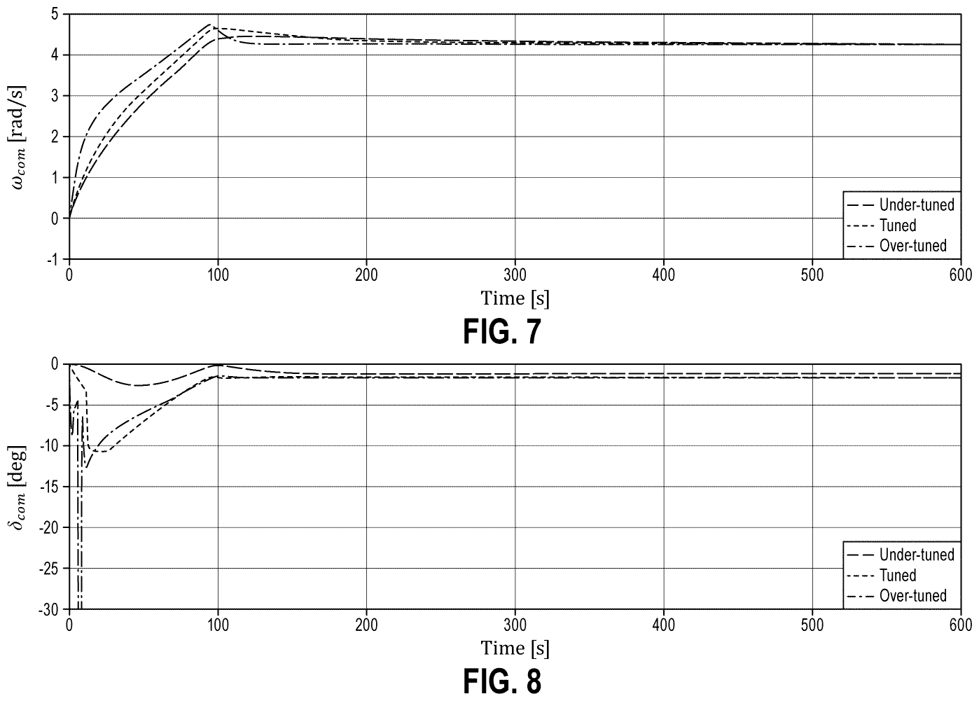

To exemplify the tuning process, FIGS. 6-8 show the open-loop trajectory tracking and actuator signals of an exemplary subscale marine surface vessel model for a circular trajectory starting at rest. For an under-tuned open-loop controller where the bandwidth ω_{n,diff} is too small, there may be a lack of initial acceleration. This may produce a large initial error that leads to a large deviation from the nominal trajectory. An over-tuned controller with a very high ω_{n,diff} may produce good initial acceleration and initial tracking. However, the actuators may show excessively high rate of activities, which may cause actuator wear-and-tear, or actuator saturation that leads to instability in closed-loop control. A well-tuned controller may produce a good trade-off in both tracking performance and actuator signal demand. It is worth noting that the observed increasing position error is not due to instability. Rather, they are the cumulative errors from the initial transient response, which can be eliminated by the feedback controller. The diameter of the steady-state circular orbits are also about 10% smaller than the nominal. This may be the result of about 4% rudder allocation error, which can be compensated for by the feedback controller.

### Error Feedback Stabilizing Controller Design

The tracking error controller 52 may be designed to exponentially stabilize the deviations of the sensed values from their corresponding nominal trajectories. The tracking error signals for each loop may be defined as follows:

$${P}_{err} = {P}_{sen} - {P}_{com} \qquad Eqn . 29$$

$${V}_{err} = {V}_{sen} - {V}_{com} \qquad Eqn . 30$$

$${ψ}_{err} = {ψ}_{sen} - {ψ}_{com} \qquad Eqn . 31$$

$${r}_{err} = {r}_{sen} - {r}_{com} \qquad Eqn . 32$$

where the command yaw angle signal ψ_{com}=tan⁻¹(F_{y,com}/F_{x,com}) for F_{x,com}>0 and tan⁻¹(F_{y,com}/F_{x,com}+π) for F_{x,com}<0.

The error dynamics may then be derived by taking the derivatives of Equations 29-32, which in general are nonlinear and time-varying. Exponential stability may be guaranteed by a linear control law for the linearized tracking error dynamics. A detailed explanation of this process can be found in U.S. Pat. No. 11,366,478, issued Jun. 1, 2022, the disclosure of which is incorporated by reference herein it its entirety.

In the translational kinematics loop, the position tracking error Pₑᵣᵣ may be rotated to the body-fixed frame to generate a down-range vector signal R_{b}:

$${R}_{b} = {[ \begin{matrix}cos ( {ψ}_{nom} ) & - sin ( {ψ}_{nom} ) \\ sin ( {ψ}_{nom} ) & cos ( {ψ}_{nom} )\end{matrix} ]}^{- 1} {P}_{err} \qquad Eqn . 33$$

The error dynamics for the b-frame position error may then be given by:

$${\dot{R}}_{b} = [ \begin{matrix}0 & {r}_{nom} \\ - {r}_{nom} & 0\end{matrix} ] {R}_{b} + {V}_{ctrl} \qquad Eqn . 34$$

The following kinematic and dynamic error dynamics may then be derived as:

$$[ \begin{matrix}{\dot{u}}_{err} \\ {\dot{v}}_{err}\end{matrix} ] = [ \begin{matrix}0 & {r}_{nom} \\ - {r}_{nom} & 0\end{matrix} ] [ \begin{matrix}{u}_{err} \\ {v}_{err}\end{matrix} ] + \frac{1}{m} [ \begin{matrix}{F}_{x , ctrl} \\ {F}_{y , ctrl}\end{matrix} ] \qquad Eqn . 35$$

$${ψ}_{ctrl} = {β}_{ctrl} = {tan}^{- 1} \frac{{v}_{err}}{{u}_{nom}} \qquad Eqn . 36$$

$${\dot{ψ}}_{err} = {r}_{ctrl} \qquad Eqn . 37$$

$${\dot{r}}_{err} = \frac{1}{{I}_{z}} {N}_{m , ctrl} \qquad Eqn . 38$$

The feedback modules 64, 66, 70, 72 may be designed as Proportional-Integral (PI) controllers such that they cancel the undesired dynamics and assign the desired closed-loop dynamic response which can be time-varying. The designed control laws that exponentially stabilize the error dynamics may be as follows:

$${V}_{ctrl} = - {K}_{P 1} {R}_{b} - {K}_{I 1} {\int }_{0}^{t} {R}_{b} d τ \qquad Eqn . 39$$

$$[ \begin{matrix}{F}_{x , ctrl} \\ {F}_{y , ctrl}\end{matrix} ] = - {K}_{P 2} [ \begin{matrix}{u}_{err} \\ {v}_{err}\end{matrix} ] - {K}_{I 2} [ \begin{matrix}{\int }_{0}^{t} {u}_{e r r} d τ \\ {\int }_{0}^{t} {v}_{e r r} d τ\end{matrix} ] \qquad Eqn . 40$$

$${r}_{ctrl} = - {K}_{P 3} {ψ}_{e r r} - {K}_{I 3} {\int }_{0}^{t} {ψ}_{e r r} d τ \qquad Eqn . 41$$

$${N}_{m , ctrl} = - {K}_{P 4} {r}_{e r r} - {K}_{I 4} {\int }_{0}^{t} {r}_{e r r} d τ \qquad Eqn . 42$$

$${K}_{P 1} ( t ) = [ \begin{matrix}{a}_{111} ( t ) & {r}_{n o m} \\ - {r}_{nom} & {a}_{121} ( t )\end{matrix} ]$$

$${K}_{I 1} ( t ) = [ \begin{matrix}{a}_{112} ( t ) & 0 \\ 0 & {a}_{122} ( t )\end{matrix} ]$$

where:

$${K}_{P 2} ( t ) = m [ \begin{matrix}{a}_{211} ( t ) & {r}_{n o m} \\ - {r}_{nom} & {a}_{221} ( t )\end{matrix} ]$$

$${K}_{12} ( t ) = m [ \begin{matrix}{a}_{212} ( t ) & 0 \\ 0 & {a}_{222} ( t )\end{matrix} ]$$

$${K}_{P 3} ( t ) = {a}_{311} ( t )$$

$${K}_{I 3} ( t ) = {a}_{312} ( t )$$

$${K}_{P 4} ( t ) = {I}_{z} {a}_{411} ( t )$$

$${K}_{I 4} ( t ) = {I}_{z} {a}_{412} ( t )$$

$${a}_{ij 1} ( t ) = 2 {ζ}_{i j} {ω}_{n i j} ( t ) \qquad Eqn . 43$$

$${a}_{ij 2} ( t ) = {ω}_{n i j}^{2} ( t ) - \frac{{\dot{ω}}_{n i j} ( t )}{{ω}_{n i j} ( t )} \qquad Eqn . 44$$

and:

The constant damping ratio ζᵢⱼ and time varying bandwidth \dot{ω}_{n,ij}(t) may be used to synthesize the desired feedback control response for the loop. Note that when ω_{n,ij}(t)=0 Equations 43 and 44 may reduce to the constant eigenvalues λᵢⱼ=−ζωₙ±jωₙ\sqrt{1−ζ²}.

Equations 39-42 may be referred to as proportional-integral control laws, and the coefficients aᵢⱼ₁ and aᵢⱼ₂ may be used to assign the desired feedback control response for the loop. The command control signal generated by each controller loop may be the sum of the nominal control signal and the feedback control signal, e.g., *com=*nom+*ctrl. In particular, the force command signal F_{com} and moment command signal N_{m,com} may be used to determine the actuator command signals for the one or more actuators of the marine surface vessel.

The dynamics of the actuators may be ignored in the above controller design because it can be viewed as a singular perturbation to the closed-loop system with a bandwidth much larger than the highest bandwidth in the closed-loop controller. The bandwidth ωₙᵢⱼ may be initially set to:

$${ω}_{nij} = \frac{1}{3} {ω}_{n , act} ( i + 1 ) l$$

and the innermost loop bandwidth may be set to:

$${ω}_{n 4 , 1} < \frac{1}{3} {ω}_{n , act}$$

Bandwidth tuning may be performed starting from the innermost loop and moving out one loop at a time.

### Control Allocation

The actuator command signals may be calculated from the force and moment command signals as follows:

$${Fc}_{x , nom} = {F}_{x , nom} - {F}_{H , xnom} - {F}_{D , xnom} \qquad Eqn . 45$$

$${Fc}_{x , com} = {Fc}_{x , nom} + {Fc}_{x , ctrl} \qquad Eqn . 46$$

$${Nc}_{nom} = {Nm}_{nom} - {N}_{H , nom} - {N}_{D , nom} \qquad Eqn . 47$$

$${Nc}_{com} = {Nc}_{nom} + {Nc}_{ctrl} \qquad Eqn . 48$$

The commanded force Fc_{x,com} and torque Nc_{com} may then be used to compute ω_{sh,com} and δ_{rd,com} as follows:

$${𝒯}_{sh} = {Fc}_{x , com} + {𝒟}_{rd} \qquad Eqn . 49$$

$${ω}_{sh , com} = \sqrt{\frac{{𝒯}_{sh}}{{k}_{{𝒯}_{p}}}} \qquad Eqn . 50$$

$${δ}_{rd , com} = \frac{{N}_{C , com}}{{l}_{x} ( {𝒯}_{sh} ( 1 + {k}_{{ℒ}_{n}} {ω}_{sh} ) ( {k}_{{ℒδ}_{1}} ) )} \qquad Eqn . 51$$

### III. Experimental Results

A circular test trajectory was used to verify the implementation of the multi-nested loop-trajectory linearization control algorithm on the subscale ship CyberShip II, and to demonstrate the control algorithm's effectiveness by establishing a baseline performance.

The actuator model has been modified to match the under-actuation condition of the present work, i.e., no lateral thruster is used. The marine surface vessel model parameters are taken from R. e. a. Skjetne, “Adaptive maneuvering, with experiments, for a model ship in a marine control laboratory,” Automatica, vol. 44, pp. 289-298 February 2005, and K. Lindegaard and T. Fossen, “Fuel-efficient rudder and propeller control allocation for marine craft: Experiments with a model ship,” IEEE Transactions on Control Systems Technology, vol. 11, pp. 850-862, November 2003, with adaptation to an equivalent single propeller-rudder configuration. The actuator saturation limits are set to max(|δ_{rd}|)=30 degrees and max(|ωₛₕ|)=16 rad/s.

TABLE II
CONTROLLER PARAMETERS

| | | | |
|---|---|---|---|
| Guidance Outer | Guidance Inner | Steering Outer | Steering Inner |
| Loop | Loop | Loop | Loop |

Nominal controller

| | | | | |
|---|---|---|---|---|
| ζ | [0.9 0.9] | [1.4 1.4] | 1.4 | 1.4 |
| ωₙ | [10 10] | [1/27 1/21] | 1/5 | 1 |

Feedback Controller

| | | | | |
|---|---|---|---|---|
| ζ | [0.9 0.9] | [1.4 0.7] | 1.4 | 0.9 |
| ωₙ | [1/500 1/500] | [1/45 1/75] | 1/15 | 1/3 |

There are three types of trajectories with constant ū that may be considered. These trajectories are, in order of tracking control challenge levels:
1) Straight line: Unaccelerated with constant ψₙₒₘ and ramp Pₙₒₘ, and zero nominal sideslip angle βₙₒₘ.
2) Circle: Unaccelerated with ramp ψₙₒₘ, sinusoidal Pₙₒₘ, and constant nominal sideslip angle βₙₒₘ.
3) Sine wave: accelerated with sinusoidal vₙₒₘ, rₙₒₘ, ψₙₒₘ, and nominal sideslip angle βₙₒₘ.

Experimental results are not shown for the first type of trajectory because it is the easiest trajectory to track. The tuned controller parameters for all trajectories are summarized in Table II above.

### Test Trajectory Two—Circular Trajectory

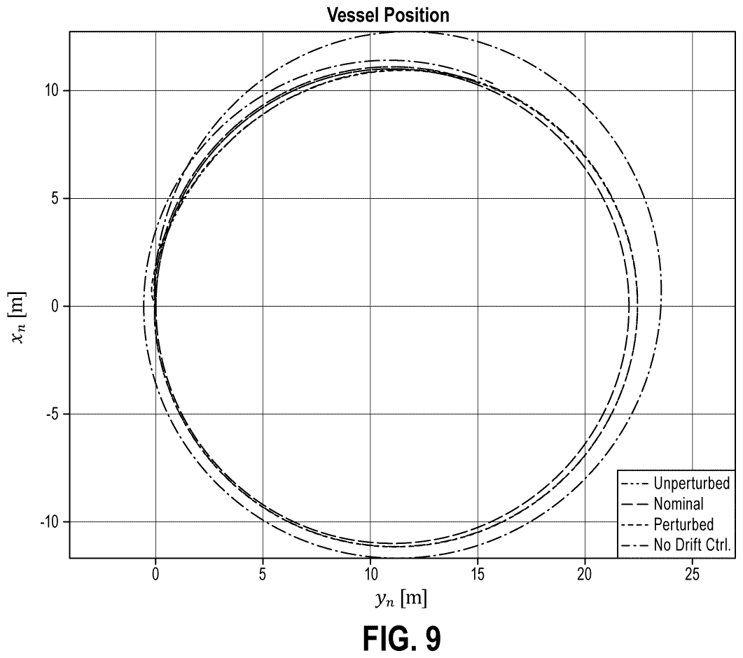

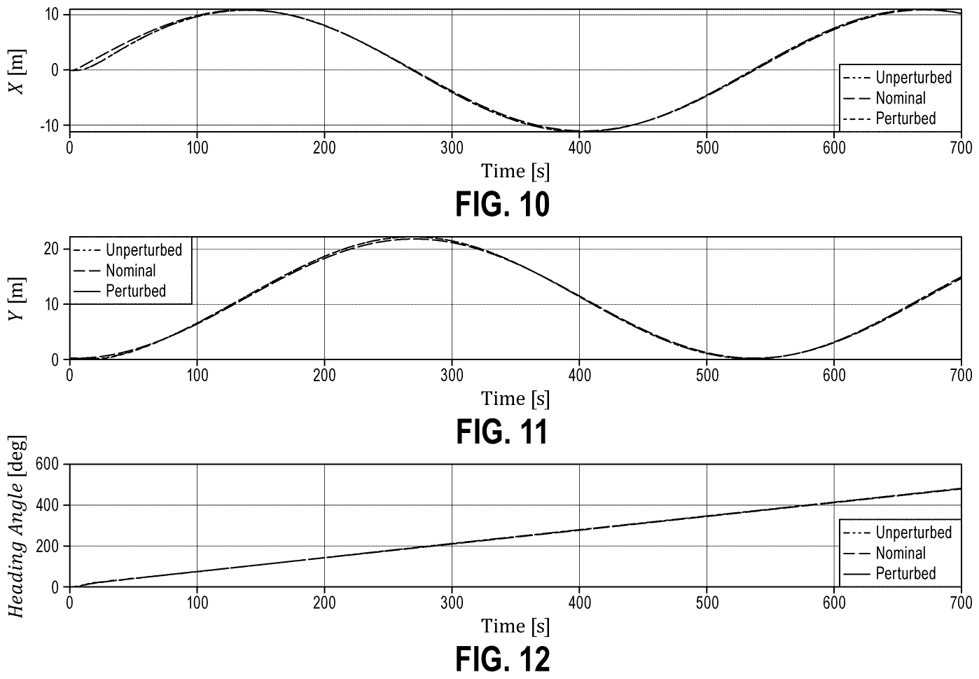

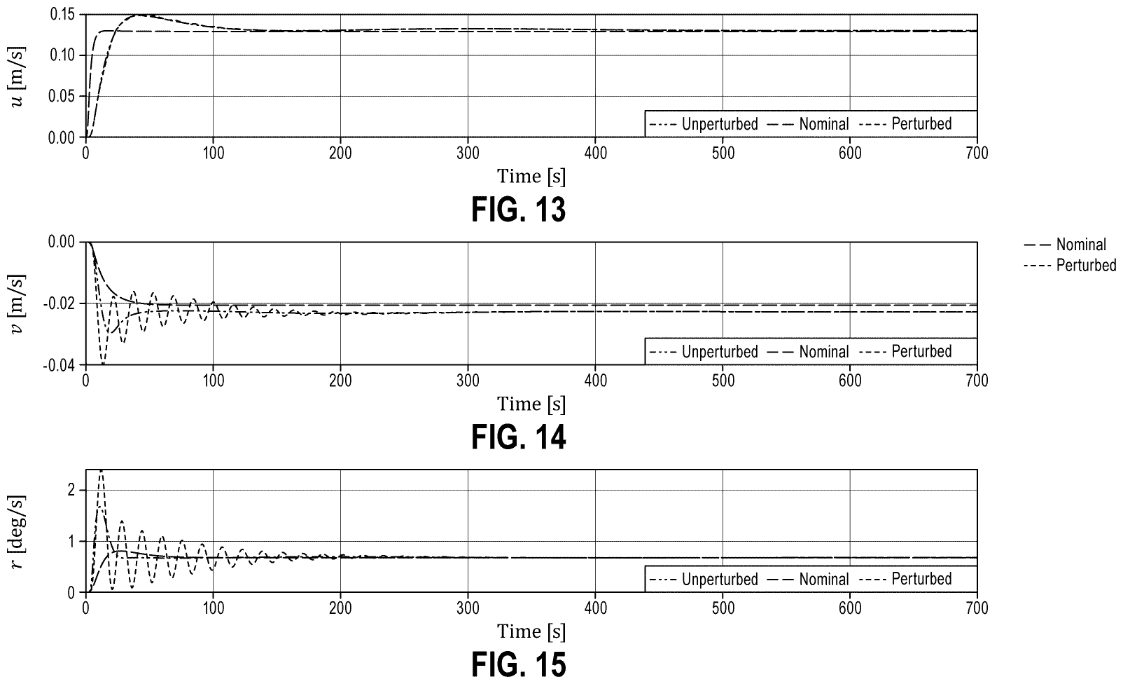

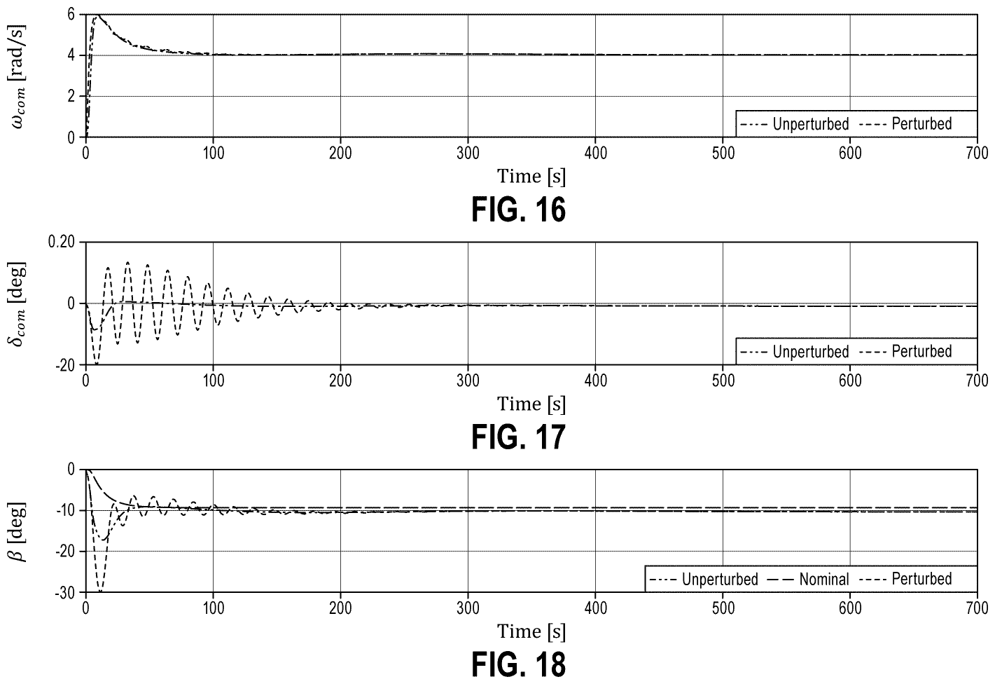

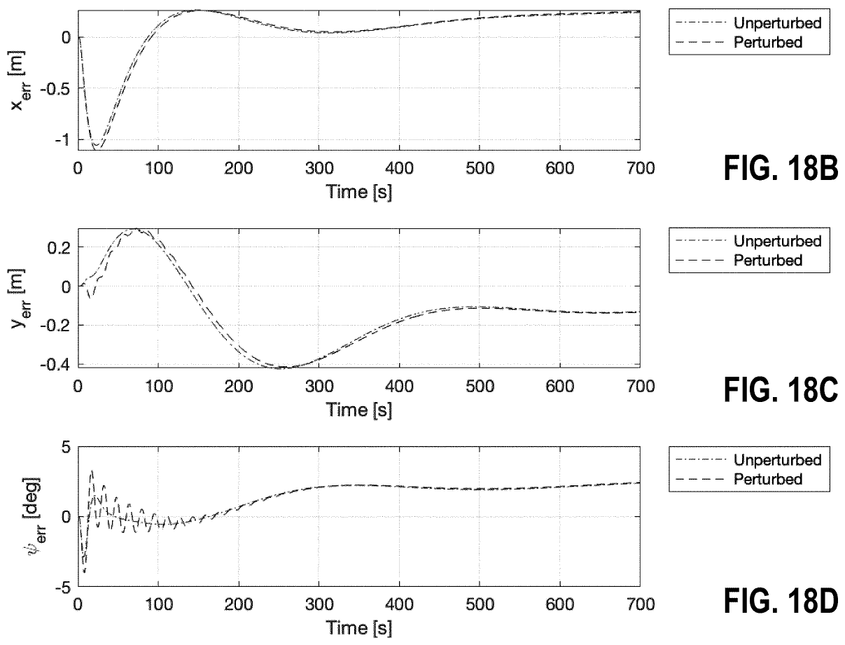

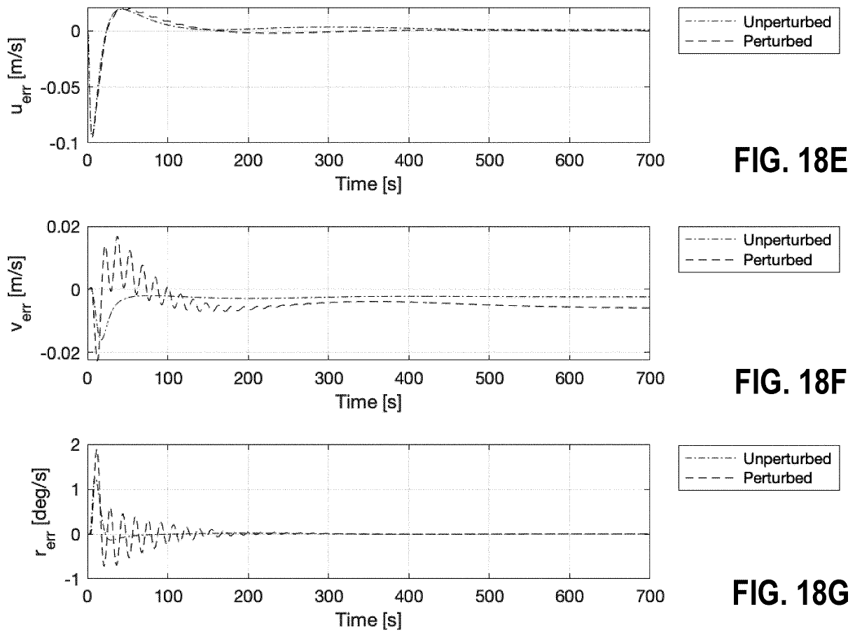

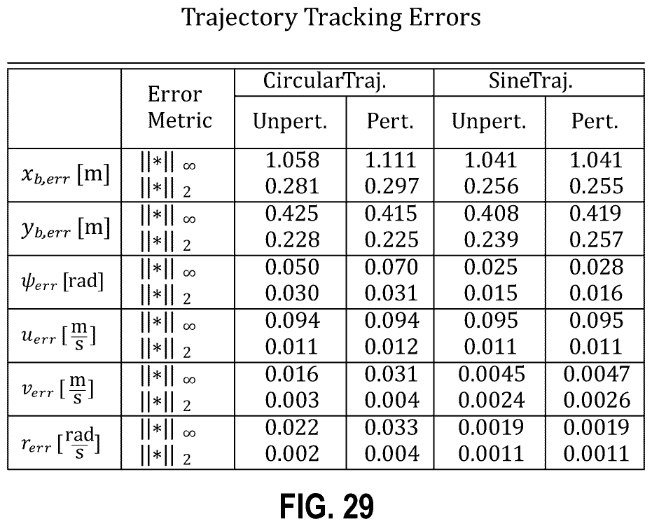

A circular trajectory is used to demonstrate both accelerated tracking in the transient phase and un-accelerated tracking performance in steady-state. The radius of the circle is R=11 m and the steady-state tangential velocity of V=0.13 m/s. The simulation results are shown in FIGS. 9-18. While the cumulative open-loop tracking error appears large, as shown in FIG. 6, the initial errors are sufficiently small so that the feedback control based on the trajectory linearization is exponentially stable and robust. The closed loop response is a clear improvement over the open loop control response, with smooth and benign actuator activities. The proportional-integral control law for each of the four loops is a Type-I system with zero steady-state error for constant inputs. However the kinematics variables have nonzero steady-state errors due to the sinusoidal trajectories. To further reduce these steady-state errors, a Type-II controller can be employed at the cost of reduced agility and stability margins. To exemplify the stability robustness, simulation results for a 6 times mismatched I_{z} for the vessel model and the controller, which may happen in practice by cargo distribution on a ship, are also shown in FIGS. 9-18G. The tracking error for unperturbed and perturbed cases are summarized in the table depicted by FIG. 29. It may be of particular interest to note that the sideslip angle β in the test data depicted by FIGS. 16-18 has a non-negligible rate of change and has a steady-state values around 11 degrees. This demonstrates that the restrictions on the sideslip angle β as disclosed by T. I. Fossen, K. Y. Pettersen, and R. Galeazzi, “Line-of-sight path following for dubins paths with adaptive sideslip compensation of drift forces,” IEEE Transactions on Control Systems Technology, vol. 23, no. 2, pp. 820-827, 2014., have been overcome by the proposed marine surface vessel trajectory linearization control system. Furthermore, FIG. 9 shows that the proposed lateral force generation algorithm yields a clear improvement over the case without it. In this case, the peak lateral error ∥y_{b,err}∥_{∞} is reduced from 1.93 m to 0.42 m, which is an improvement of about 3.5 times. In addition, the Root-Mean-Square (RMS) error ∥y_{b,err}∥₂ goes from 1.05 m to 0:23 m, which is an improvement of about 3.6 times.

### Test Trajectory Three—Sinusoidal Trajectory

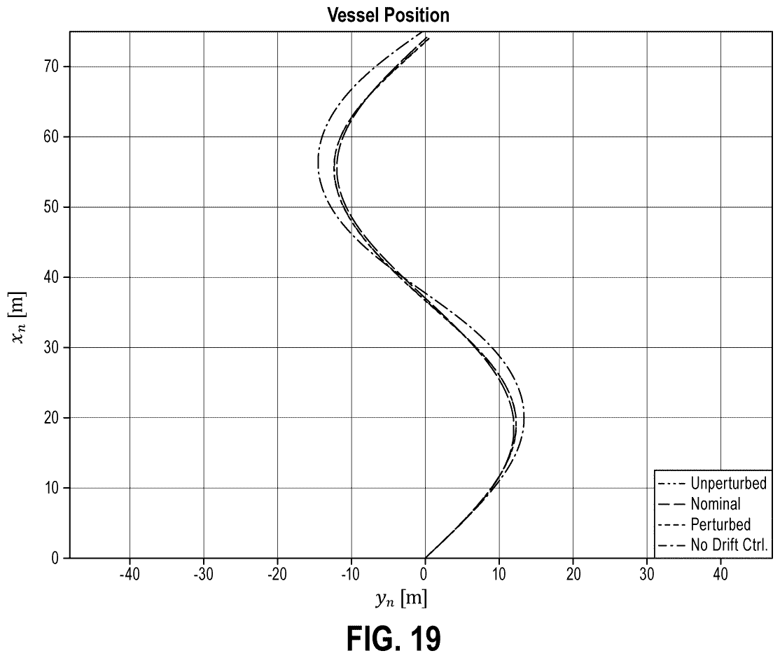

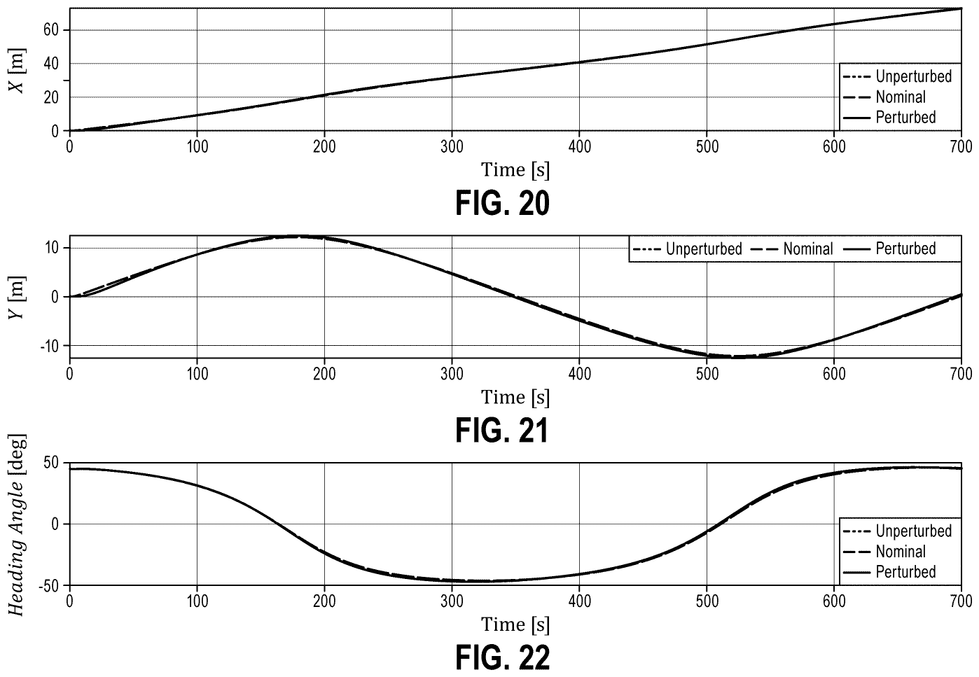

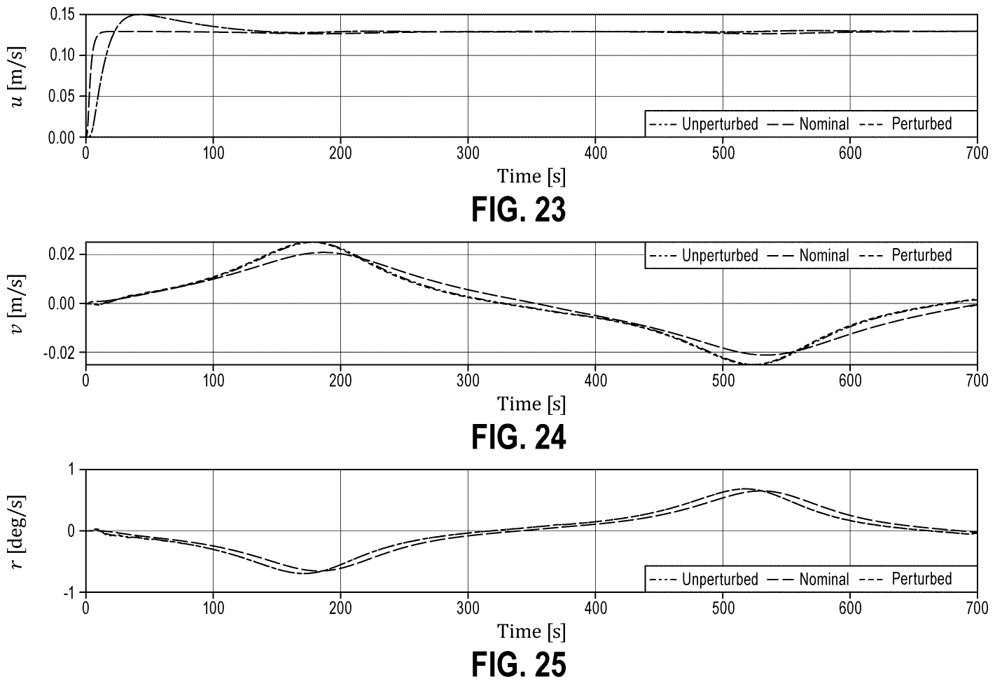

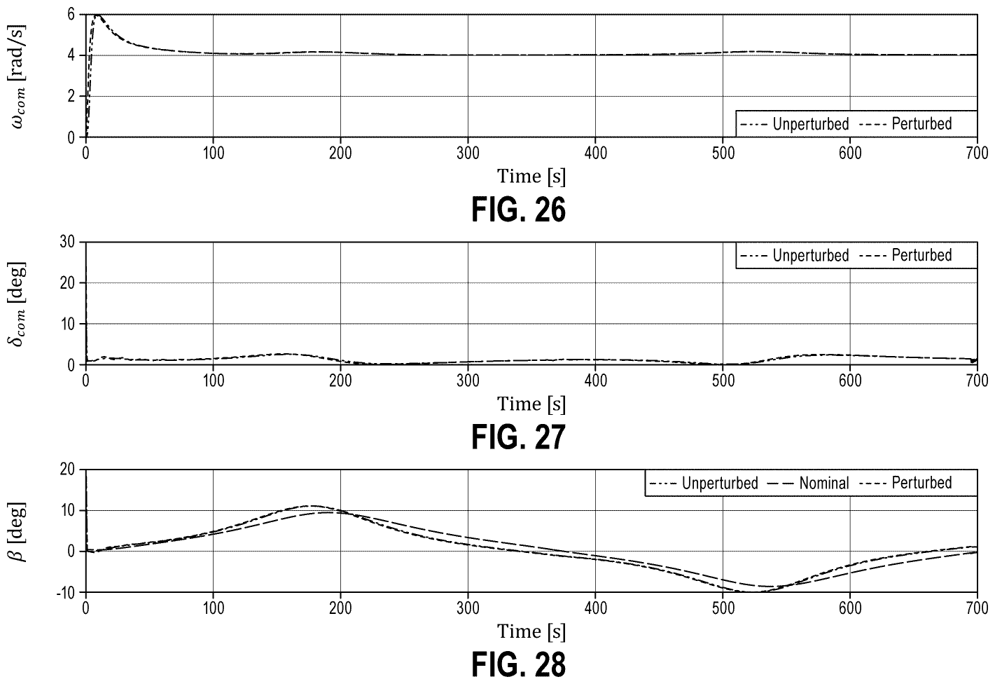

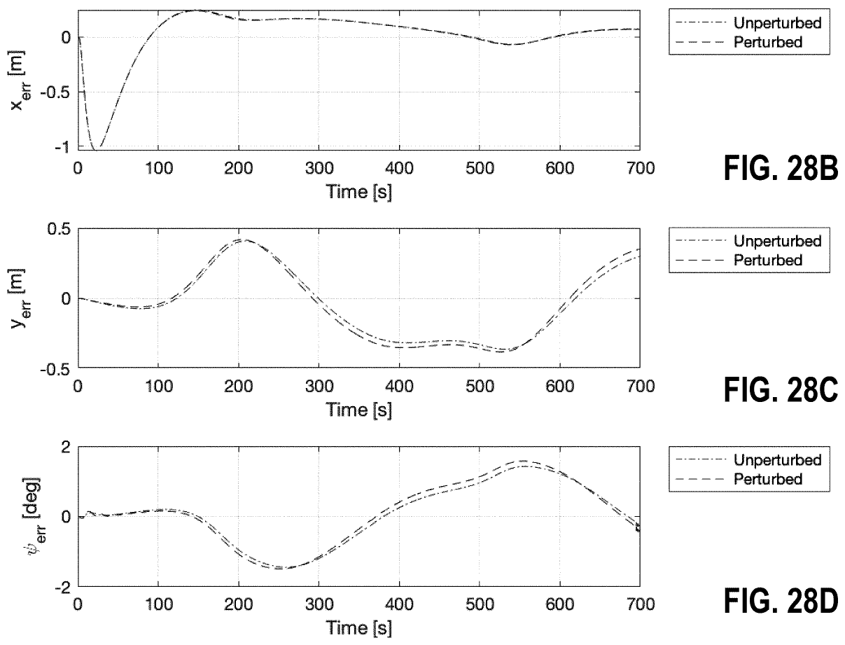

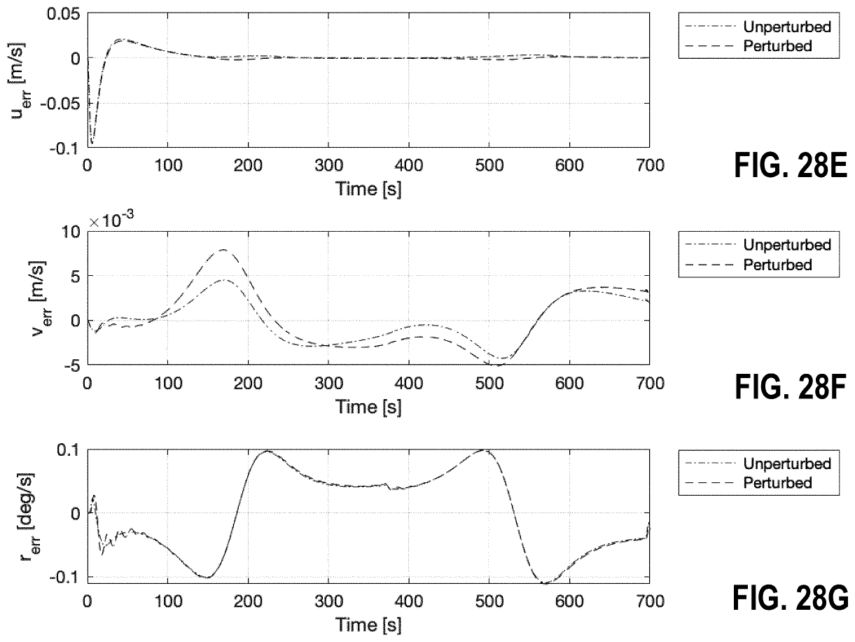

A sinusoidal trajectory with amplitude of 12 m and a wavelength of 74 m is used to demonstrate accelerated tracking with variant rₙₒₘ, vₙₒₘ and β in both the transient and steady-state tracking performance, which is a more challenging task as compared to the steady set point in the generalized velocities vₙₒₘ and rₙₒₘ of the circular trajectory. The results are shown in FIGS. 19-28G. A 5 times I_{z} perturbation case is also included. Tracking error metrics for both circular and sinewave trajectories with and without I_{z} perturbations are summarized FIG. 29. Notably, the I_{z} perturbations had minimal effects for both trajectories. The allowable perturbation is limited by integrator windup.

### Conclusions

An integrated three degrees of freedom trajectory tracking control system based on a multi-nested loop trajectory linearization control architecture for under-actuated marine surface vehicles has been disclosed. This is considered a complex control challenge. The challenge of lateral drift when turning is tackled by using the sideslip angle β as a virtual control effector. A novel method is disclosed for determining the nominal sideslip angle βₙₒₘ based on the reference kinematic pose and the dynamic forces along a nominal trajectory. This approach enables an under-actuated marine surface vessel to track an accelerated trajectory with a 3.5 times reduction in lateral tracking error under closed-loop control, as demonstrated by simulation with a realistic subscale vessel model. Guidelines and demonstrative examples on the tuning of inverse dynamics in the open loop nominal controller have been presented, which provide an insight on the response of the nominal controller and its effects on the overall controller transient response, steady-state tracking errors, and resulting actuator activities. Simulation results for the closed-loop tracking of a circular and a sinewave trajectory demonstrate tracking performance of both unaccelerated and accelerated trajectories. The robustness of the controller is demonstrated by simulations of circular and sinusoidal trajectories with 6 times and 5 times mismatch of the yaw moment of inertia I_{z}, respectively, in the vessel and controller. These simulations show minimal performance degradation.

As used herein, the term “module” refers to any hardware, software, or combination thereof that provides the functionality associated with the described module. Modules may include analog circuitry, digital circuity, program code, or any combination thereof, that performs one or more functions associated with the functionality of the module. In some embodiments, a module may comprise program code that is part of a larger program including multiple modules which, when executed by a computer, provides a desired function or set of functions.

As used herein the term “signal” may refer to any digital or analog signal conveying information, e.g., information that defines a value of a parameter such as a velocity, heading, yaw rate, force, etc. The value of the parameter may be defined by a voltage, current, phase, amplitude, or any other suitable characteristic of the signal. In cases where the signal is a digital signal, the value may be represented by a digital number stored in or generated by a computer.

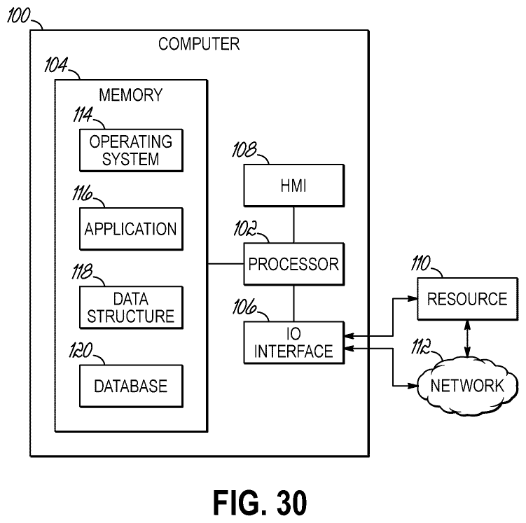

Referring now to FIG. 30, embodiments of the invention described above, or portions thereof, may be implemented using one or more computing devices or systems, such as exemplary computer 100. The computer 100 may include a processor 102, a memory 104, an input/output (I/O) interface 106, and a Human Machine Interface (HMI) 108. The computer 100 may also be operatively coupled to one or more external resources 110 via a network 112 or I/O interface 106. External resources may include, but are not limited to, servers, databases, mass storage devices, peripheral devices, cloud-based network services, or any other resource that may be used by the computer 100.

The processor 102 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions stored in memory 104. Memory 104 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or data storage devices such as a hard drive, optical drive, tape drive, volatile or non-volatile solid state device, or any other device capable of storing data.

The processor 102 may operate under the control of an operating system 114 that resides in memory 104. The operating system 114 may manage computer resources so that computer program code embodied as one or more computer software applications, such as an application 116 residing in memory 104, may have instructions executed by the processor 102. In an alternative embodiment, the processor 102 may execute the application 116 directly, in which case the operating system 114 may be omitted. One or more data structures 118 may also reside in memory 104, and may be used by the processor 102, operating system 114, or application 116 to store or manipulate data.

The I/O interface 106 may provide a machine interface that operatively couples the processor 102 to other devices and systems, such as the external resource 110 or the network 112. The application 116 may thereby work cooperatively with the external resource 110 or network 112 by communicating via the I/O interface 106 to provide the various features, functions, applications, processes, or modules comprising embodiments of the invention. The application 116 may also have program code that is executed by one or more external resources 110, or otherwise rely on functions or signals provided by other system or network components external to the computer 100. Indeed, given the nearly endless hardware and software configurations possible, persons having ordinary skill in the art will understand that embodiments of the invention may include applications that are located externally to the computer 100, distributed among multiple computers or other external resources 110, or provided by computing resources (hardware and software) that are provided as a service over the network 112, such as a cloud computing service.

The HMI 108 may be operatively coupled to the processor 102 of computer 100 to allow a user to interact directly with the computer 100. The HMI 108 may include video or alphanumeric displays, a touch screen, a speaker, and any other suitable audio and visual indicators capable of providing data to the user. The HMI 108 may also include input devices and controls such as an alphanumeric keyboard, a pointing device, keypads, pushbuttons, control knobs, microphones, etc., capable of accepting commands or input from the user and transmitting the entered input to the processor 102.

A database 120 may reside in memory 104, and may be used to collect and organize data used by the various systems and modules described herein. The database 120 may include data and supporting data structures that store and organize the data. In particular, the database 120 may be arranged with any database organization or structure including, but not limited to, a relational database, a hierarchical database, a network database, or combinations thereof. A database management system in the form of a computer software application executing as instructions on the processor 102 may be used to access the information or data stored in records of the database 120 in response to a query, which may be dynamically determined and executed by the operating system 114, other applications 116, or one or more modules.

In general, the routines executed to implement the embodiments of the invention, whether implemented as part of an operating system or a specific application, component, program, object, module or sequence of instructions, or a subset thereof, may be referred to herein as “program code.” Program code typically comprises computer-readable instructions that are resident at various times in various memory and storage devices in a computer and that, when read and executed by one or more processors in a computer, cause that computer to perform the operations necessary to execute operations or elements embodying the various aspects of the embodiments of the invention. Computer-readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, or operations specified in the text of the specification, the flowcharts, sequence diagrams, or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, or operations specified in the text of the specification, flowcharts, sequence diagrams, or block diagrams.

The flowcharts and block diagrams depicted in the figures illustrate the architecture, functionality, or operation of possible implementations of systems, methods, or computer program products according to various embodiments of the invention. In this regard, each block in the flowchart or block diagrams may represent a module, segment, or portion of instructions, which comprises one or more executable instructions for implementing the specified logical function or functions.

In certain alternative embodiments, the functions, acts, or operations specified in the text of the specification, the flowcharts, sequence diagrams, or block diagrams may be re-ordered, processed serially, or processed concurrently consistent with embodiments of the invention. Moreover, any of the flowcharts, sequence diagrams, or block diagrams may include more or fewer blocks than those illustrated consistent with embodiments of the invention. It should also be understood that each block of the block diagrams or flowcharts, or any combination of blocks in the block diagrams or flowcharts, may be implemented by a special purpose hardware-based system configured to perform the specified functions or acts, or carried out by a combination of special purpose hardware and computer instructions.

The terminology used herein is for the purpose of describing particular embodiments only and is not intended to be limiting of the embodiments of the invention. As used herein, the singular forms “a”, “an” and “the” are intended to include both the singular and plural forms, and the terms “and” and “or” are each intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method of controlling a marine surface vessel including one or more actuators, comprising:
receiving a nominal position signal and a nominal heading signal each corresponding to a planned trajectory of the marine surface vessel in a navigation frame;
generating a plurality of nominal control signals based on one or more of the nominal position signal and the nominal heading signal, the nominal control signals including a nominal force signal and a nominal moment signal;
receiving a plurality of sensed value signals including a sensed position signal, a sensed velocity signal, a sensed yaw angle signal, and a sensed yaw rate signal;
generating a plurality of tracking error signals including a position tracking error signal generated based on the sensed position signal, a velocity tracking error signal generated based on the sensed velocity signal, a yaw angle tracking error signal generated based on the sensed yaw angle signal, and a yaw rate tracking error signal generated based on the sensed yaw rate signal;
generating a plurality of tracking error control signals including a velocity tracking error control signal generated based on the position tracking error signal, a force tracking error control signal generated based on the velocity tracking error signal, a yaw tracking error control signal generated based on a sway component of the velocity tracking error signal, and a moment tracking error control signal generated based on the yaw rate tracking error signal;
generating a plurality of command signals including a force command signal generated by summing the nominal force signal and the force tracking error control signal and a moment command signal generated by summing the nominal moment signal and the moment tracking error control signal; and
controlling the one or more actuators of the marine surface vessel based on the force command signal and the moment command signal.

2. The method of claim 1, wherein generating the nominal force signal comprises:
pseudo-differentiating the nominal position signal to generate an n-frame nominal velocity signal;
applying a first inverse translational kinematics function including a nominal yaw angle signal as a coefficient of rotation to the n-frame nominal velocity signal to generate a b-frame nominal velocity signal;
pseudo-differentiating the nominal b-frame velocity signal to generate a b-frame nominal acceleration signal; and
applying an inverse translational dynamics function including the nominal yaw rate signal, the b-frame nominal velocity signal, the b-frame nominal acceleration signal, and a mass of the marine surface vessel to generate the b-frame nominal force signal.

3. The method of claim 1, wherein generating the force tracking error control signal comprises:
subtracting a sensed position signal from the nominal position signal to generate an n-frame position tracking error signal;
applying the inverse translational kinematics function including the nominal yaw angle signal as the coefficient of rotation to the position tracking error signal to generate a b-frame down-range error vector signal;
applying a first proportional-integral control law to the b-frame down-range error vector signal to generate a velocity tracking error control signal;
summing the nominal velocity signal and the velocity tracking error control signal to generate a velocity command signal;
subtracting the sensed velocity signal from the velocity command signal to generate the velocity tracking error signal; and
applying a second proportional-integral control law to the velocity tracking error signal to generate the force tracking error control signal.

4. The method of claim 1, wherein generating the force command signal comprises:
summing the nominal force signal and the force tracking error control signal.

5. The method of claim 1, wherein generating the moment tracking error control signal comprises:
generating a yaw angle command signal based on the force command signal;
subtracting a sensed yaw angle signal from the yaw angle command signal to generate a yaw angle tracking error signal;
applying a third proportional-integral control law to the yaw angle tracking error signal to generate a yaw rate tracking error control signal;
summing the yaw rate tracking error control signal and the nominal yaw rate signal to generate a yaw rate command signal;
subtracting the sensed yaw rate signal from the yaw rate command signal to generate the yaw rate tracking error signal; and
applying a fourth proportional-integral control law to the yaw rate tracking error signal to generate the moment tracking error control signal.

6. The method of claim 1, wherein generating the moment command signal comprises:
summing the nominal moment signal and the moment tracking error control signal.

7. The method of claim 1, wherein generating the nominal moment signal comprises:
using the nominal lateral force signal to compute a nominal sideslip angle signal based on the vessel's inverse force model;
subtracting the nominal sideslip angle signal from the nominal heading angle signal and lowpass filtering the difference to generate a nominal yaw angle signal;
pseudo-differentiating the nominal yaw angle signal to generate a nominal yaw rate signal;
pseudo-differentiating the nominal yaw rate signal to generate a nominal yaw acceleration signal, and
multiplying the nominal yaw acceleration signal by a rotational inertia of the marine surface vessel to generate the nominal moment signal.

8. The method of claim 7, wherein determining the nominal yaw angle signal comprises:
generating a nominal velocity signal based on the nominal position signal;
generating a nominal yaw rate signal based on the nominal heading signal;
generating a nominal force signal including a nominal surge component and a nominal sway component based on the nominal yaw rate signal and the nominal velocity signal;
determining a required sway velocity to overcome the lateral drift based on the sway component of the nominal force signal and the vessel's force model parameters;
generating a nominal sideslip signal based on a ratio of the required sway velocity to the surge component of the nominal velocity; and
subtracting the nominal sideslip signal from the nominal heading signal to generate the nominal yaw angle signal.

9. The method of claim 8, wherein generating the nominal velocity signal comprises:
applying a second inverse translational kinematics function including the nominal heading signal as the coefficient of rotation to the pseudo-differentiated n-frame nominal position signal to generate the nominal b-frame velocity signal.

10. The method of claim 8, wherein generating the nominal yaw rate signal comprises:
pseudo-differentiating the nominal heading signal to generate the nominal yaw rate signal.

11. The method of claim 8, wherein the marine surface vessel has a mass, and generating the nominal force signal comprises:
pseudo-differentiating the nominal velocity signal to generate a nominal acceleration signal;
applying a second inverse translational dynamics function including the nominal yaw rate signal as the coefficient of rotation to the nominal velocity signal to generate a result;
subtracting the result from the nominal acceleration signal to generate a difference; and
multiplying the difference by the mass of the marine surface vessel to generate the nominal force signal.

12. A system for controlling a marine surface vessel including one or more actuators, comprising:
one or more processors; and
a memory coupled to the one or more processors and including program code that, when executed by the one or more processors, causes the system to:
receive a nominal position signal and a nominal heading signal each corresponding to a planned trajectory of the marine surface vessel in a navigation frame;
generate a plurality of nominal control signals based on one or more of the nominal position signal and the nominal heading signal, the nominal control signals including a nominal force signal and a nominal moment signal;
receive a plurality of sensed value signals including a sensed position signal, a sensed velocity signal, a sensed yaw angle signal, and a sensed yaw rate signal;
generate a plurality of tracking error signals including a position tracking error signal generated based on the sensed position signal, a velocity tracking error signal generated based on the sensed velocity signal, a yaw angle tracking error signal generated based on the sensed yaw angle signal, and a yaw rate tracking error signal generated based on the sensed yaw rate signal;
generate a plurality of tracking error control signals including a velocity tracking error control signal generated based on the position tracking error signal, a force tracking error control signal generated based on the velocity tracking error signal, a yaw tracking error control signal generated based on a sway component of the velocity tracking error signal, and a moment tracking error control signal generated based on the yaw rate tracking error signal;
generate a plurality of command signals including a force command signal generated by summing the nominal force signal and the force tracking error control signal and a moment command signal generated by summing the nominal moment signal and the moment tracking error control signal; and
control the one or more actuators of the marine surface vessel based on the force command signal and the moment command signal.

13. The system of claim 12, wherein generating the nominal force signal comprises:
pseudo-differentiating the nominal position signal to generate an n-frame nominal velocity signal;
applying a first inverse translational kinematics function including a nominal yaw angle signal as a coefficient of rotation to the n-frame nominal velocity signal to generate a b-frame nominal velocity signal;
pseudo-differentiating the nominal b-frame velocity signal to generate a b-frame nominal acceleration signal; and
applying an inverse translational dynamics function including the nominal yaw rate signal, the b-frame nominal velocity signal, the b-frame nominal acceleration signal, and a mass of the marine surface vessel to generate the b-frame nominal force signal.

14. The system of claim 12, wherein generating the force tracking error control signal comprises:
subtracting a sensed position signal from the nominal position signal to generate an n-frame position tracking error signal;
applying the inverse translational kinematics function including the nominal yaw angle signal as the coefficient of rotation to the position tracking error signal to generate a b-frame down-range error vector signal;
applying a first proportional-integral control law to the b-frame down-range error vector signal to generate a velocity tracking error control signal;
summing the nominal velocity signal and the velocity tracking error control signal to generate a velocity command signal;
subtracting the sensed velocity signal from the velocity command signal to generate the velocity tracking error signal; and
applying a second proportional-integral control law to the velocity tracking error signal to generate the force tracking error control signal.

15. The system of claim 12, wherein generating the force command signal comprises:
summing the nominal force signal and the force tracking error control signal.

16. The system of claim 12, wherein generating the moment tracking error control signal comprises:
generating a yaw angle command signal based on the force command signal;
subtracting a sensed yaw angle signal from the yaw angle command signal to generate a yaw angle tracking error signal;
applying a third proportional-integral control law to the yaw angle tracking error signal to generate a yaw rate tracking error control signal;
summing the yaw rate tracking error control signal and the nominal yaw rate signal to generate a yaw rate command signal;
subtracting the sensed yaw rate signal from the yaw rate command signal to generate the yaw rate tracking error signal; and
applying a fourth proportional-integral control law to the yaw rate tracking error signal to generate the moment tracking error control signal.

17. The system of claim 12, wherein generating the moment command signal comprises:
summing the nominal moment signal and the moment tracking error control signal.

18. The system of claim 12, wherein generating the nominal moment signal comprises:
using the nominal lateral force signal to compute a nominal sideslip angle signal based on the vessel's inverse force model;
subtracting the nominal sideslip angle signal from the nominal heading angle signal and lowpass filtering the difference to generate a nominal yaw angle signal;
pseudo-differentiating the nominal yaw angle signal to generate a nominal yaw rate signal;
pseudo-differentiating the nominal yaw rate signal to generate a nominal yaw acceleration signal, and
multiplying the nominal yaw acceleration signal by a rotational inertia of the marine surface vessel to generate the nominal moment signal.

19. The system of claim 18, wherein determining the nominal yaw angle signal comprises:
generating a nominal velocity signal based on the nominal position signal;
generating a nominal yaw rate signal based on the nominal heading signal;
generating a nominal force signal including a nominal surge component and a nominal sway component based on the nominal yaw rate signal and the nominal velocity signal;
determining a required sway velocity to overcome the lateral drift based on the sway component of the nominal force signal and the vessel's force model parameters;
generating a nominal sideslip signal based on a ratio of the required sway velocity to the surge component of the nominal velocity; and
subtracting the nominal sideslip signal from the nominal heading signal to generate the nominal yaw angle signal.

20. The system of claim 19, wherein generating the nominal velocity signal comprises:
applying a second inverse translational kinematics function including the nominal heading signal as the coefficient of rotation to the pseudo-differentiated n-frame nominal position signal to generate the nominal b-frame velocity signal.

21. The system of claim 20, wherein generating the nominal yaw rate signal comprises:
pseudo-differentiating the nominal heading signal to generate the nominal yaw rate signal.

22. The system of claim 20, wherein the marine surface vessel has a mass, and generating the nominal force signal comprises:
pseudo-differentiating the nominal velocity signal to generate a nominal acceleration signal;
applying a second inverse translational dynamics function including the nominal yaw rate signal as the coefficient of rotation to the nominal velocity signal to generate a result;
subtracting the result from the nominal acceleration signal to generate a difference; and
multiplying the difference by the mass of the marine surface vessel to generate the nominal force signal.

23. A computer program product for controlling a marine surface vessel including one or more actuators, comprising:
a non-transitory computer-readable storage medium; and
program code stored on the non-transitory computer-readable storage medium that, when executed by one or more processors, causes the one or more processors to:
receive a nominal position signal and a nominal heading signal each corresponding to a planned trajectory of the marine surface vessel in a navigation frame;
generate a plurality of nominal control signals based on one or more of the nominal position signal and the nominal heading signal, the nominal control signals including a nominal force signal and a nominal moment signal;
receive a plurality of sensed value signals including a sensed position signal, a sensed velocity signal, a sensed yaw angle signal, and a sensed yaw rate signal;
generate a plurality of tracking error signals including a position tracking error signal generated based on the sensed position signal, a velocity tracking error signal generated based on the sensed velocity signal, a yaw angle tracking error signal generated based on the sensed yaw angle signal, and a yaw rate tracking error signal generated based on the sensed yaw rate signal;
generate a plurality of tracking error control signals including a velocity tracking error control signal generated based on the position tracking error signal, a force tracking error control signal generated based on the velocity tracking error signal, a yaw tracking error control signal generated based on a sway component of the velocity tracking error signal, and a moment tracking error control signal generated based on the yaw rate tracking error signal;
generate a plurality of command signals including a force command signal generated by summing the nominal force signal and the force tracking error control signal and a moment command signal generated by summing the nominal moment signal and the moment tracking error control signal; and
control the one or more actuators of the marine surface vessel based on the force command signal and the moment command signal.
